(19) United States
(12) Patent Application Publication
(10) Pub. No.: US 2009/0084131 A1
(43) Pub. Date: Apr. 2, 2009

(54) Air Conditioning Units with Modular Heat Exchangers, Inventories, Buildings, and Methods

(75) Inventors: Allan J. Reifel, Florrisant, MO (US); Jie Chen, St. Charles, MO (US); James S. Kistler, Chesterfield, MO (US); Russell W. Hoeffken, Millstadt, IL (US)

Correspondence Address: BRYAN CAVE LLP, TWO NORTH CENTRAL AVENUE, SUITE 2200, PHOENIX, AZ, 85004, US

(73) Assignee: NORDYNE Inc., O'Fallon, MO (US)

(21) Appl. No.: 11/865,575

(22) Filed: Oct. 1, 2007

(51) Int. Cl. F25B 39/02; B23P 15/26; F25D 13/00

(52) U.S. Cl. 62/515; 29/890.035; 62/440

(57) ABSTRACT

Air conditioning units, methods of manufacturing, inventories, and buildings wherein certain heat exchanger modules are combined to make air conditioning units. In some embodiments, different combinations of different size modules are used to produce air conditioning units having different capacities wherein some identical modules are used in different size units. Various heat exchanger assemblies include spacers between modules, bends formed after modules are assembled into heat exchanger assemblies, attachment rails at the ends of the modules, inactive multi-tubes at the top and bottom of the modules, copper tubing between aluminum modules to facilitate field replacement of individual modules, name plates that attach between modules, attachment clips or spacers that snap attach to the modules, or a combination thereof, as examples.

### FIELD OF THE INVENTION

This Invention relates to air conditioning units, methods of manufacturing air conditioning units, inventories of air conditioning units, and buildings having air conditioning units. Various embodiments include heat exchangers that are formed from multiple heat exchanger modules.

### BACKGROUND OF THE INVENTION

Air conditioning units have been used, for example, to change the temperature within buildings to provide a comfortable and safe environment for people to live or work. A wide range of different size air conditioning units have been designed and built for different size buildings, for example, or buildings with different cooling loads. Air conditioning manufacturers have typically offered a number of different sizes of air conditioning units, and customers typically have selected the size unit that was adequate for their needs, without being excessive.

In the past, air conditioning units have been manufactured using heat exchangers that serve as the condenser and the evaporator transferring heat between a refrigerant and air, for instance. Such heat exchangers have included multiple passes arranged in series with respect to the flow of the refrigerant, and arranged in parallel with respect to the flow of air, as examples. The standard practice has been to design, manufacture, and stockpile inventories of heat exchangers for each size air conditioning unit. Generally, each size air conditioning unit required its own size heat exchangers, and separate inventories of heat exchangers had to be maintained for each size (i.e., capacity) unit at or near the location of assembly of the air conditioning units. If inventories of heat exchangers for one size air conditioning unit were exhausted, it was necessary to stop production of that size unit until heat exchangers of the proper size and configuration were obtained, often from a distant supplier or manufacturer configurations and methods of manufacturing air conditioning units of different sizes wherein inventories of heat exchangers can be reduced, wherein different size air conditioning units can be manufactured using the same heat exchanger components, or both, as examples. Needs or potential for benefit also exist for inventories of such air conditioning units, and buildings having such air conditioning units.

Furthermore, in the past, when a heat exchanger in an air conditioning unit was damaged, was found to contain an unrepairable defect, became clogged, or the like, it was typically necessary to replace the entire heat exchanger assembly, if not the entire air conditioning unit. Air conditioning unit heat exchangers have often been made of aluminum, and typical service and installation personnel for such units (e.g., for residential applications) have not had available the necessary equipment, components, and skills to make suitable connections to aluminum heat exchanger components in the field. Thus, needs and potential for benefit exist for air conditioning units, and inventories thereof, wherein part or all of heat exchangers can be replaced in the field, using techniques practiced by typical air conditioning service and installation personnel. Needs and potential for benefit also exist for buildings having such air conditioning units.

Furthermore, owners and users of air conditioning units have grown to expect long life and efficient service from air conditioning units, and yet tremendous competition exists for the market for air conditioning units, for example, for residential applications. Thus, needs and potential for benefit exist for air conditioning units, inventories thereof, methods of making and distributing them, and buildings containing such units, that are reliable, inexpensive, reduce need for inventories, have short manufacturing times, and produce high quality. Room for improvement exists over prior art in these and other areas that may be apparent to a person of ordinary skill in the art having studied this document.

### SUMMARY OF PARTICULAR EMBODIMENTS TO THE INVENTION

This invention provides, among other things, various methods of manufacturing different capacity air conditioning units using common heat exchanger modules, air conditioning units that include heat exchanger modules, inventories of different capacity air conditioning units that contain different combinations of heat exchanger modules, and buildings that include such air conditioning units, as examples. Particular embodiments include particular features that provide certain benefits, at least in particular applications, and certain embodiments are limited to particular configurations of heat exchangers, air conditioning units, or the like.

Various embodiments provide, as objects or benefits, for example, that they provide air conditioning unit configurations and methods of manufacturing air conditioning units of different sizes wherein inventories of heat exchangers can be reduced, wherein different size air conditioning units can be manufactured using the same heat exchanger components, or both, as examples. Some embodiments further provide air conditioning units, and methods of making and distributing them, that are reliable, inexpensive, reduce need for inventories, have short manufacturing times, and produce high quality units. Other benefits of certain embodiments may be apparent to a person of ordinary skill in the art.

In specific embodiments, this invention provides various methods of manufacturing different capacity air conditioning units using common heat exchanger modules. These methods include (e.g., in any order, except where order is explicitly indicated), various combinations of certain acts. In many embodiments, for example, such acts include obtaining an inventory of substantially identical first heat exchanger modules, obtaining an inventory of substantially identical second heat exchanger modules, and obtaining an inventory of substantially identical third heat exchanger modules. In many such embodiments, the second heat exchanger modules have at least one dimension that is significantly different than a corresponding dimension on the first heat exchanger module, the third heat exchanger modules have at least one dimension that is significantly different than a corresponding dimension on the first heat exchanger module, and the third heat exchanger modules have at least one dimension that is significantly different than a corresponding dimension on the second heat exchanger module.

Such methods may also include an act of assembling multiple first capacity substantially identical first air conditioning units using, for each first air conditioning unit, at least one first heat exchanger module, at least one second heat exchanger module, and no third heat exchanger module. In a number of embodiments, the assembling of each first air conditioning unit includes assembling the at least one first heat exchanger module and the at least one second heat exchanger module to form a first heat exchanger assembly, and then installing the first heat exchanger assembly as a unit. Further, in many embodiments, the assembling of each first air conditioning unit includes connecting refrigerant conduit between the first heat exchanger module and the second heat exchanger module. Further, in some embodiments, the assembling of each first air conditioning unit further includes installing a first fan and a first electric motor, wherein the first electric motor drives the first fan and the first fan is positioned within the first air conditioning unit to move air through the first heat exchanger assembly.

These methods may also include an act of assembling multiple second capacity substantially identical second air conditioning units using, for each second air conditioning unit, at least one second heat exchanger module and at least one third heat exchanger module. In many embodiments, the assembling of each second air conditioning unit includes assembling (at least) the at least one second heat exchanger module and the at least one third heat exchanger module to form a second heat exchanger assembly, and then installing the second heat exchanger assembly as a unit. In addition, in a number of embodiments, the assembling of each second air conditioning unit includes connecting refrigerant conduit between the second heat exchanger module and the third heat exchanger module. Further, in some embodiments, the assembling of each second air conditioning unit further includes installing a second fan and a second electric motor, wherein the second electric motor drives the second fan and the second fan is positioned within the second air conditioning unit to move air through the second heat exchanger assembly. In certain of these embodiments, the second capacity of the second air conditioning units is significantly different than the first capacity of the first air conditioning units.

In particular such methods, the act of connecting refrigerant conduit between the first heat exchanger module and the second heat exchanger module in the first heat exchanger assembly includes connecting the first heat exchanger module and the second heat exchanger module in series with respect to refrigerant that passes through the first heat exchanger assembly, each of the first heat exchanger module and the second heat exchanger module forming at least one complete pass of the first heat exchanger assembly. Similarly, in many embodiments, the connecting of refrigerant conduit between the second heat exchanger module and the third heat exchanger module in the second heat exchanger assembly includes connecting the second heat exchanger module and the third heat exchanger module in series with respect to refrigerant that passes through the second heat exchanger assembly, each of the second heat exchanger module and the third heat exchanger module forming at least one complete pass of the second heat exchanger assembly.

On the other hand, in some embodiments, the connecting of refrigerant conduit between the first heat exchanger module and the second heat exchanger module in the first heat exchanger assembly includes connecting the first heat exchanger module and the second heat exchanger module in parallel with respect to refrigerant that passes through the first heat exchanger assembly, each of the first heat exchanger module and the second heat exchanger module forming multiple passes of the first heat exchanger assembly. Similarly, in particular embodiments, the act of connecting refrigerant conduit between the second heat exchanger module and the third heat exchanger module in the second heat exchanger assembly includes connecting the second heat exchanger module and the third heat exchanger module in parallel with respect to refrigerant that passes through the second heat exchanger assembly, each of the second heat exchanger module and the third heat exchanger module forming multiple passes of the second heat exchanger assembly.

In addition, in some embodiments, the acts of obtaining the inventories of the first, second, and third heat exchanger modules include obtaining heat exchanger modules that each have a different number of fins per unit of length. Moreover, in certain embodiments, the acts of obtaining the inventories of the first, second, and third heat exchanger modules include obtaining heat exchanger modules that each include multiple parallel multi-tubes, each multi-tube having multiple contiguous parallel refrigerant passageways arranged in at least one row, wherein each multi-tube is substantially parallel to a direction of refrigerant flow within the multi-tube. Further, in many such embodiments, each row is substantially parallel to a direction of air flow at the row, and each heat exchanger includes multiple fins between the multi-tubes, wherein the fins are bonded to the multi-tubes. Furthermore, in some of these embodiments, the acts of obtaining the inventories of the first, second, and third heat exchanger modules include obtaining heat exchanger modules that each include a refrigerant header at each end of each heat exchanger module. In various embodiments, each header is connected to each multi-tube of the module for the passage of the refrigerant through the multi-tube, except for a top and a bottom multi-tube of each module, which are not connected to the headers for passage of the refrigerant.

Moreover, in particular embodiments, the acts of obtaining the inventories of the first, second, and third heat exchanger modules include obtaining second heat exchanger modules having an overall width dimension that is significantly different than a corresponding overall width dimension of the first heat exchanger modules, obtaining third heat exchanger modules having an overall width dimension that is significantly different than the corresponding overall width dimension of the second heat exchanger modules, and obtaining third heat exchanger modules having an overall width dimension that is significantly different than the corresponding overall width dimension of the first heat exchanger modules. Further, in some such embodiments, the act of assembling the first heat exchanger assembly includes arranging the at least one first heat exchanger module and the at least one second heat exchanger module in parallel with respect to air that passes through the first heat exchanger assembly. Similarly, in some embodiments, the act of assembling the second heat exchanger assembly includes arranging the at least one second heat exchanger module and the at least one third heat exchanger module in parallel with respect to air that passes through the second heat exchanger assembly.

Still further, some such methods further include, after the act of assembling the at least one first heat exchanger module and the at least one second heat exchanger module to form the first heat exchanger assembly, and before the act of installing the first heat exchanger assembly as a unit, an additional act of bending the first heat exchanger assembly as a unit. Similarly, in some of these embodiments, such a method further includes, after the act of assembling the at least one second heat exchanger module and the at least one third heat exchanger module to form the second heat exchanger assembly, and before the act of installing the second heat exchanger assembly as a unit, an additional act of bending the second heat exchanger assembly as a unit.

Going further, in some embodiments, the act of bending the second heat exchanger assembly as a unit includes making at least one substantially right-angle bend in the second heat exchanger module and the third heat exchanger module. Still further, in some embodiments, the act of making at least one bend in the first heat exchanger assembly includes making precisely three substantially right-angle bends in the first heat exchanger module and the second heat exchanger module. Some such methods further include additional acts of installing an electrically driven first compressor within each first air conditioning unit, and installing an electrically driven second compressor within each second air conditioning unit, wherein the second compressor has a significantly different capacity than the first compressor.

In various embodiments, the assembling of each first heat exchanger assembly includes placing a spacer between the first heat exchanger module and the second heat exchanger module to form the first heat exchanger assembly, and then installing the first heat exchanger assembly as a unit. Similarly, in some embodiments, the assembling of each second heat exchanger assembly includes placing a spacer between the second heat exchanger module and the third heat exchanger module to form the second heat exchanger assembly, and then installing the second heat exchanger assembly as a unit. In some embodiments, the heat exchanger modules may snap to or into the spacers, for instance. Further, in some embodiments, after the acts of installing the first heat exchanger and assembling the first air conditioning unit (at least as recited above), are completed, an act of attaching a name plate to each of the first air conditioning units may be performed, the name plate including a brand name of the first air conditioning unit. This act of attaching may include, for example, attaching the name plate to the spacer, or attaching the name plate to the heat exchanger assembly between the modules, or at a location where there is a gap in the spacer, as examples.

In some particular embodiments, the act of assembling each first heat exchanger assembly includes attaching the first heat exchanger module and the second heat exchanger module to at least a first attachment rail, which has a long dimension that is substantially parallel to the width of the first heat exchanger module and substantially parallel to the width of the second heat exchanger module, for instance. In certain embodiments, the first heat exchanger assembly may be bent as a unit, and then installed as a unit. Similarly, in some embodiments, the assembling of each second heat exchanger assembly includes attaching the second heat exchanger module and the third heat exchanger module to at least a second attachment rail, wherein the second attachment rail has a long dimension that is substantially parallel to the width of the second heat exchanger module and substantially parallel to the width of the third heat exchanger module, then bending the second heat exchanger assembly as a unit, and then installing the second heat exchanger assembly as a unit, for example.

Even further, in some embodiments, the assembling of each first heat exchanger assembly includes attaching the first heat exchanger module and the second heat exchanger module to a first attachment rail at a first end of the first and second heat exchanger modules, and attaching the first heat exchanger module and the second heat exchanger module to a second attachment rail at a second end of the first and second heat exchanger modules. In many such embodiments, each of the first and second attachment rails has a long dimension that is substantially parallel to the width of the first heat exchanger module and substantially parallel to the width of the second heat exchanger module. After the first and second heat exchanger modules are attached to the first and second attachment rails in some such embodiments, particular methods also include the act of installing the first heat exchanger assembly as a unit.

Other specific embodiments of the invention provide specific air conditioning units. For example, some embodiments provide a first air conditioning unit that includes a first heat exchanger assembly that includes at least a first heat exchanger module and a second heat exchanger module, wherein the first heat exchanger module is stacked on top of the second heat exchanger module, and wherein the first heat exchanger module and the second heat exchanger module are arranged in parallel with respect to air that passes through the first heat exchanger assembly. In many such embodiments, the first heat exchanger assembly includes connecting refrigerant conduit (e.g., tubing) between the first heat exchanger module and the second heat exchanger module such that the first heat exchanger module and the second heat exchanger module are arranged in series with respect to refrigerant that passes through the first heat exchanger assembly, each of the first heat exchanger module and the second heat exchanger module forming at least one complete pass of the first heat exchanger assembly.

In many of these embodiments, for example, each of the first and second heat exchanger modules include multiple parallel multi-tubes, the multi-tubes in each heat exchanger module being parallel to each other geometrically and arranged in parallel with respect to the flow of the refrigerant, each multi-tube having multiple contiguous parallel refrigerant passageways arranged in at least one row, and wherein each heat exchanger module includes multiple fins between the multi-tubes, wherein the fins are bonded to the multi-tubes. Many such air conditioning units also include a first fan positioned and configured to move air through the first heat exchanger assembly, a first electric motor for driving the first fan, and a first compressor configured to compress refrigerant.

Some embodiments further include a spacer between the first heat exchanger module and the second heat exchanger module, and the spacer may be configured to significantly reduce the amount of air that passes between the first heat exchanger module and the second heat exchanger module. In particular embodiments, the spacer consists essentially of an extruded piece of material containing cuts in particular locations to provide for bending of the spacer at corners of the first heat exchanger assembly. Further, in some embodiments, the first air conditioning unit further includes a name plate attached to the air conditioning unit, wherein the name plate includes a brand name of the air conditioning unit, and wherein the name plate is attached to the spacer or to the heat exchanger assembly at a location where there is a gap in the spacer. In some of these embodiments, the heat exchanger module includes multiple substantially right-angle bends at corresponding locations in the first heat exchanger module, the spacer, and the second heat exchanger module.

Further, in some embodiments of the first air conditioning unit, each heat exchanger module includes a refrigerant header at each end of the heat exchanger module, and each header is connected to each multi-tube of the module for the passage of the refrigerant through the multi-tube, except for a top and a bottom multi-tube of each module, which are not connected to the headers for passage of the refrigerant. Further still, in some embodiments, the first heat exchanger module and the second heat exchanger module each consist essentially of aluminum, and the connecting refrigerant conduit between the first heat exchanger module and the second heat exchanger module includes a section of copper tubing connected to the aluminum. Such a presence of the copper tubing may facilitate field replacement of the first heat exchanger module without replacing the second heat exchanger module, for example.

In certain embodiments, the heat exchanger module includes three substantially right-angle bends at corresponding locations in the first heat exchanger module and the second heat exchanger module, and the second heat exchanger modules have an overall width dimension that is significantly different than a corresponding overall width dimension of the first heat exchanger modules. Further, in some embodiments, the first air conditioning unit further includes a first attachment rail attached to a first end of the first and second heat exchanger modules, and a second attachment rail attached to a second end of the first and second heat exchanger modules, wherein each of the first and second attachment rails has a long dimension that is substantially parallel to the width of the first heat exchanger module and substantially parallel to the width of the second heat exchanger module.

In various embodiments, the first air conditioning unit further includes multiple attachment center clips attaching adjacent heat exchanger modules at an inside surface of the heat exchanger assembly. Other, or the same embodiments, include a top housing section, wherein the first motor is attached to the top housing section, and multiple attachment top clips attaching the heat exchanger assembly to the top housing section. In addition, some embodiments include a base section, wherein the first compressor is attached to the base section, the first air conditioning unit further including multiple attachment bottom clips attaching the heat exchanger assembly to the base section, for example.

Other specific embodiments of the invention include an inventory of air conditioning units, including multiple first air conditioning units such as those described above, wherein the inventory further includes multiple second air conditioning units. These second air conditioning units may each include, for example, a second heat exchanger assembly including at least a second heat exchanger module and a third heat exchanger module, and no first heat exchanger module, wherein the second heat exchanger module and the third heat exchanger module are arranged in parallel with respect to air that passes through the second heat exchanger assembly.

In many such embodiments, the second heat exchanger assembly includes connecting refrigerant conduit between the second heat exchanger module and the third heat exchanger module, and each of the second and third heat exchanger modules include multiple parallel multi-tubes, the multi-tubes in each heat exchanger module being parallel to each other geometrically and arranged in parallel with respect to the flow of the refrigerant. Similar to some other embodiments, each multi-tube may have multiple contiguous parallel refrigerant passageways arranged in at least one row, and each heat exchanger module may include multiple fins between the multi-tubes, wherein the fins are bonded to the multi-tubes. In various embodiments, such second air conditioning units may also each include a second fan positioned and configured to move air through the second heat exchanger assembly, a third electric motor for driving the second fan, and a second compressor configured to compress refrigerant.

In many embodiments, at least before the first heat exchanger assemblies and the second heat exchanger assemblies are assembled, the second heat exchanger modules of the first heat exchanger assemblies and the second heat exchanger modules of the second heat exchanger assemblies are interchangeable. Furthermore, in many embodiments, the second air conditioning units have a capacity that is significantly different than a capacity of the first air conditioning units, and the third heat exchanger modules have at least one dimension that is significantly different than a corresponding dimension on the first heat exchanger modules. In yet another specific embodiment, this invention also provides a building that includes the first air conditioning unit described above, wherein the building forms an enclosure containing a space having a temperature that is conditioned by the first air conditioning unit.

This invention also provides other embodiments, such as other air conditioning units, that include other combinations of features described above. An example is a first air conditioning unit that includes a first heat exchanger assembly include at least a first heat exchanger module and a second heat exchanger module, wherein the first heat exchanger module and the second heat exchanger module are arranged in parallel with respect to air that passes through the first heat exchanger assembly, and the first heat exchanger module, a first fan positioned and configured to move air through the first heat exchanger assembly, a first electric motor for driving the first fan, a first compressor configured to compress refrigerant, and at least one other feature.

An example of this other feature is the spacer between the first heat exchanger module and the second heat exchanger module, wherein the spacer is configured to significantly reduce the amount of air that passes between the first heat exchanger module and the second heat exchanger module, and wherein there are multiple substantially right-angle bends at corresponding locations in the first heat exchanger module, the spacer, and the second heat exchanger module. Another example of this other feature is aluminum, wherein the first heat exchanger module and the second heat exchanger module each consist essentially of the aluminum, and a connecting refrigerant conduit is provided between the first heat exchanger module and the second heat exchanger module that includes a section of copper tubing connected at each end to the aluminum, wherein the presence of the copper tubing facilitates field replacement of the first heat exchanger module without replacing the second heat exchanger module.

Still another example of this other feature is the multiple parallel multi-tubes in each heat exchanger module, the multi-tubes being parallel to each other geometrically and arranged in parallel with respect to the flow of the refrigerant, each multi-tube having multiple contiguous parallel refrigerant passageways arranged in at least one row, and multiple fins between the multi-tubes, wherein the fins are bonded to the multi-tubes, and a refrigerant header at each end of each heat exchanger module, wherein each header is connected to each multi-tube of the module for the passage of the refrigerant through the multi-tube, except for a top and a bottom multi-tube of each module, wherein the top and bottom multi-tubes of each module are not connected to the headers for passage of the refrigerant.

Even another example of this other feature is a first attachment rail attached to a first end of the first and second heat exchanger modules, and a second attachment rail attached to a second end of the first and second heat exchanger modules, wherein each of the first and second attachment rails has a long dimension that is substantially parallel to the width of the first heat exchanger module and substantially parallel to the width of the second heat exchanger module.

And another example of this other feature includes multiple attachment center clips attaching adjacent heat exchanger modules at an inside surface of the heat exchanger assembly, a top housing section, wherein the first motor is attached to the top housing section, the first air conditioning unit further include multiple attachment top clips attaching the heat exchanger assembly to the top housing section, and a base section, wherein the first compressor is attached to the base section, the first air conditioning unit further include multiple attachment bottom clips attaching the heat exchanger assembly to the base section.

Such embodiments may also include other features described herein, or may be, for example, an inventory of air conditioning units, including multiple of these first air conditioning units, wherein the inventory further includes muiltiple second air conditioning units, which may have various features described herein for the first or second air conditioning units. These second air conditioning units may have a capacity that is significantly different than a capacity of the first air conditioning units, and the third heat exchanger modules (i.e., within the second air conditioning units) may have at least one dimension that is significantly different than a corresponding dimension on the first heat exchanger modules. In addition, other embodiments of the invention are also described herein.

### BRIEF DESCRIPTION OF THE DRAWINGS

FIG. 1 is an isometric view illustrating, among other things, an example of an inventory of two different sizes of air conditioning units, namely, condensing units for a split system;

FIG. 2 is an isometric view illustrating the smaller of the two air conditioning units of FIG. 1, and also illustrating, in a block diagram form, an example of an air handler, certain additional components of the air conditioning system, and an example of a building, the internal temperature of which is conditioned by the air conditioning system;

FIG. 3 is a back view of the air conditioning unit of FIG. 2 with the rear panel removed so that certain internal components are visible, including the fan, compressor, and connecting refrigerant conduit or tubing;

FIG. 4 is an isometric view illustrating the larger of the two air conditioning units of FIG. 1;

FIG. 5 is a back view of the air conditioning unit of FIG. 4 with the rear panel removed so that certain internal components are visible including the fan, compressor, and connecting refrigerant conduit or tubing;

FIG. 6 is an isometric view of an example of a smaller single-pass heat exchanger module that is used in both air conditioning units of FIG. 1;

FIG. 7 is an isometric view of another example of a single-pass heat exchanger module that is larger than the heat exchanger module of FIG. 6, and that is also used in both air conditioning units of FIG. 1;

FIG. 8 is an isometric view of yet another example of a single-pass heat exchanger module, which is larger than the heat exchanger module of FIG. 7, and that is also used in both air conditioning units of FIG. 1;

FIG. 9 is an isometric view of an example of a larger single-pass heat exchanger module and that is used in the air conditioning unit of FIG. 4, but not the air conditioning unit of FIG. 2;

FIG. 10 is an isometric view of an example of a heat exchanger module that has two passes;

FIG. 11 is a back view of an example of an air conditioning unit that includes the two-pass heat exchanger module of FIG. 10, and that is shown with the rear panel removed so that certain internal components are visible;

FIG. 12 is a back isometric view of the heat exchanger assembly for the air conditioning unit of FIG. 11 that includes the two-pass heat exchanger module of FIG. 10;

FIG. 13 is a back isometric view of the heat exchanger assembly for the air conditioning unit of FIGS. 2 and 3, which includes heat exchanger modules of FIGS. 6 to 8;

FIG. 14 is the back isometric view of the heat exchanger assembly of FIG. 13, except with the top heat exchanger module removed so that the spacers, rails, clips, fasteners and name plate are more clearly visible;

FIG. 15 is a front isometric view of the heat exchanger assembly of FIGS. 13 and 14 illustrating the name plate from the front;

FIG. 16 is a back isometric view of the heat exchanger assembly for the air conditioning unit of FIGS. 4 and 5, which includes heat exchanger modules of FIGS. 6 to 9;

FIG. 17 is a cross-sectional view of an embodiment of a spacer;

FIG. 18 is a cross-sectional view of another embodiment of spacer, and also shows a side view of an example of a center clip and an example of the positional relationship therebetween;

FIG. 19 is an isometric view of an example of a two-piece spacer having the cross-section illustrated in FIG. 18, and showing a gap in the spacer where the name plate may be installed;

FIG. 20 is an isometric view of an example of a one-piece spacer having the cross-section illustrated in FIG. 18, but without a gap in the spacer where the name plate would be installed;

FIG. 21 is a closer side view of an example of two adjacent heat exchanger modules and connecting refrigerant conduit therebetween, showing, among other things, an example of the fins;

FIG. 22 is a cross-sectional view through the heat exchanger modules of FIG. 21, showing an example of the multi-tubes, fins, and spacer;

FIG. 23 is a close up view of the center of the cross-sectional view of FIG. 22, showing details of the multi-tubes and spacer;

FIG. 24 is a close isometric view of an example of two adjacent heat exchanger modules having differing thicknesses, and connecting refrigerant conduit therebetween, showing, among other things, an example of the fins and spacer;

FIG. 25 is a cross-sectional view through the heat exchanger modules of FIG. 24, showing an example of the multi-tubes, fins, and spacer;

FIG. 26 is a close isometric view of an example of two adjacent heat exchanger modules and connecting refrigerant conduit therebetween, showing, among other things, an example of installed positions of the center clip of FIG. 18, a top clip, and a bottom clip;

FIG. 27 is a cross-sectional view through the heat exchanger modules of FIG. 26, showing the installed positions of the center clip, the top clip, and the bottom clip;

FIG. 28 is an isometric view of the center clip of FIGS. 18, 26, and 27;

FIG. 29 is an isometric view of the top clip of FIGS. 26 and 27;

FIG. 30 is an isometric view of the bottom clip of FIGS. 26 and 27;

FIG. 31 is an isometric view of one end of the heat exchanger assembly of the air conditioning unit of FIGS. 2 and 3 illustrating, among other things, an example of one of the attachment rails of FIG. 14 and multiple rail clips;

FIG. 32 is a partial close-up isometric view of an example of the attachment rail of FIG. 31;

FIG. 33 is a partial close-up isometric view of an example of one of the rail clips of FIG. 31;

FIG. 34 is a close side view of an example of two adjacent heat exchanger modules having different fin spacings, and connecting refrigerant conduit therebetween;

FIG. 35 is a close-up of the center of the side view of FIG. 34, showing, among other things, the example of the differently spaced fins;

FIG. 36 is a flow chart illustrating an example of a method of manufacturing or distributing different size or capacity air conditioning units having different combinations of certain heat exchanger modules; and

FIG. 37 is a flow chart illustrating an example of a method of manufacturing one of the air conditioning units of the method of FIG. 36, illustrating how the air conditioning unit may be assembled.

The drawings illustrate, among other things, various particular examples of embodiments of the invention, and certain examples of characteristics thereof. Different embodiments of the invention include various combinations of elements or acts shown in the drawings, described herein, known in the art, or a combination thereof.

### DETAILED DESCRIPTION OF EXAMPLES OF EMBODIMENTS

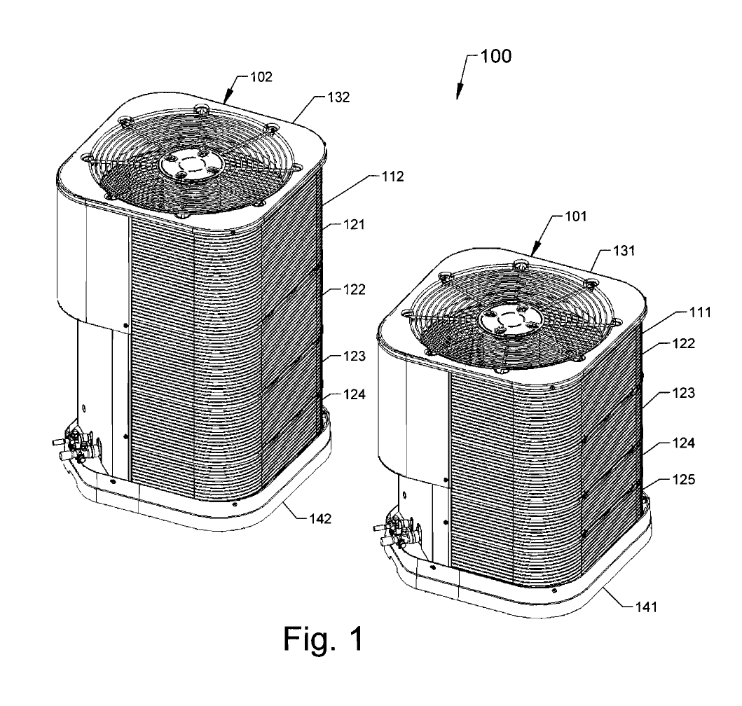

FIG. 1 shows an inventory 100 of (e.g., first and second) air conditioning units 101 and 102. As used herein, the phrase “air conditioning unit” means a packaged air conditioning unit, a split system, a condenser unit or condensing unit used in a split system, an air handler with an evaporator coil used in a split system, or a heat pump (e.g., of any such configurations). In the embodiment illustrated, air conditioning units 101 and 102 are condenser units used in split air conditioning systems (e.g., a direct expansion or DX air conditioning system), for example.

Although only one each of air conditioning units 101 and 102 are shown in FIG. 1, in many embodiments, inventory 100 may include multiple air conditioning units of each of a number of different or significantly different sizes, capacities, or configurations, as examples. In different embodiments, an inventory of air conditioning units may have 1, 2, 3, 4, 5, 6, 7, 8, 9, 10, 11, 12, 13, 14, 15, or 20 different or significantly different sizes, for instance. As shown in FIG. 1, air conditioning units 101 and 102 are different sizes (e.g., in height), and may have different or significantly different capacities (e.g., cooling capacities, tonnage, compressor sizes, compressor speeds, etc.). As used herein, “significantly different” (e.g., in dimension or capacity) means different by more than 15 percent. Although they have different heights, in some embodiments, air conditioning units 101 and 102 may have the same horizontal dimensions, while in other embodiments, such horizontal dimensions may vary between different size units.

In a number of embodiments, air conditioning units 101 and 102 may be sized, otherwise configured, marketed, or a combination thereof, for residential applications. In a particular embodiment, air conditioning unit 101 is a 2.5 ton unit, and air conditioning unit 102 is a 3.5 ton unit. In other embodiments, different air conditioning units may have capacities such as 1, 1.5, 2, 3, 4, 4.5, 5, 5.5, 6, 6.5, 7, 7.5, 8, 9, 10, 12, 15, or 20 tons, as examples, capacities therebetween, or other capacities.

In the embodiment shown, air conditioning unit 101 includes base section (base) 141, coil (e.g., condenser coil) or heat exchanger (e.g., first heat exchanger assembly) 111, and top housing section (top) 131, and air conditioning unit 102 includes base section (base) 142, coil or heat exchanger (e.g., second heat exchanger assembly) 112, and top housing section (top) 132. In some embodiments, bases 141 and 142 may be similar, substantially identical, or identical, tops 131 and 132 may be similar or identical, or both (e.g., in embodiments where units 101 and 102 have the same horizontal dimensions), except that fans, motors, compressors, etc., may be different sizes, speeds, etc., (e.g., corresponding to differences in capacity between units 101 and 102). In other embodiments, bases 141 and 142 may be different, or even significantly different, tops 131 and 132 may be different, or even significantly different, or both (e.g., in dimension, thickness of material, shape, design, etc.).

In the embodiment illustrated, heat exchanger 111 is made up of heat exchanger modules 122,123,124, and 125, and heat exchanger 112 is made up of heat exchanger modules 121, 122, 123, and 124. Although each of heat exchangers 111 and 112 of air conditioning units 101 and 102 are shown with four heat exchanger modules each, in other embodiments, heat exchangers or air conditioning units may have 2, 3, 5, 6, 7, 8, 9, 10, 11, 12, 13, 14, 15, or more heat exchanger modules. Further, in some embodiments, different size air conditioning units (e.g., within an inventory) may have different numbers of heat exchanger modules.

In various embodiments, different heat exchanger modules (e.g., 121 to 125) may have at least one dimension that is different or significantly different than a corresponding dimension in a different heat exchanger module. For example, in the embodiment illustrated, heat exchanger module 122 in heat exchanger assembly 101 has a substantially different overall vertical dimension (referred to herein as “width”, further discussed below) than heat exchanger module 123. Similarly, in the embodiment illustrated, heat exchanger module 123 in heat exchanger assembly 101 has a substantially different overall vertical dimension (width) than heat exchanger module 124. In addition, in the embodiment illustrated, heat exchanger module 121 in heat exchanger assembly 102 has a substantially different overall vertical dimension (width) than heat exchanger module 122.

In some embodiments, heat exchanger module 124 in heat exchanger assembly 101 may have a (i.e., at least one) different or substantially different dimension (e.g., width) than heat exchanger module 125, but in other embodiments, heat exchanger modules 124 and 125 may have substantially identical dimensions, or may be interchangeable. As used herein, “substantially identical” means identical (e.g., in overall and relevant dimensions) to within no more than 5 percent.

Further, heat exchanger modules (e.g., 121 to 125) having the same reference numbers (e.g., heat exchanger module 122 in heat exchanger 111 of air conditioning unit 101 and heat exchanger module 122 in heat exchanger 112 of air conditioning unit 102) may have substantially identical dimensions (e.g., width), or may be interchangeable (in different embodiments, either before or after heat exchangers 111 and 112 are assembled or bent). In many embodiments, different size or capacity air conditioning units (e.g., 101 and 102) may have one or more heat exchanger modules in common (e.g., modules 122, 123, and 124, in air conditioning units 101 and 102 in inventory 100 shown in FIG. 1) which may be interchangeable before being installed in the air conditioning units (e.g., 101 and 102) or before being assembled or bent, for instance. For example, significantly different size air conditioning units may have 1, 2, 3, 4, 5, 6, 7, or more modules in common, but may have 1, 2, 3, 4, 5, 6, or more other modules that are found one size unit but not another size unit. Other size units may have different modules in common.

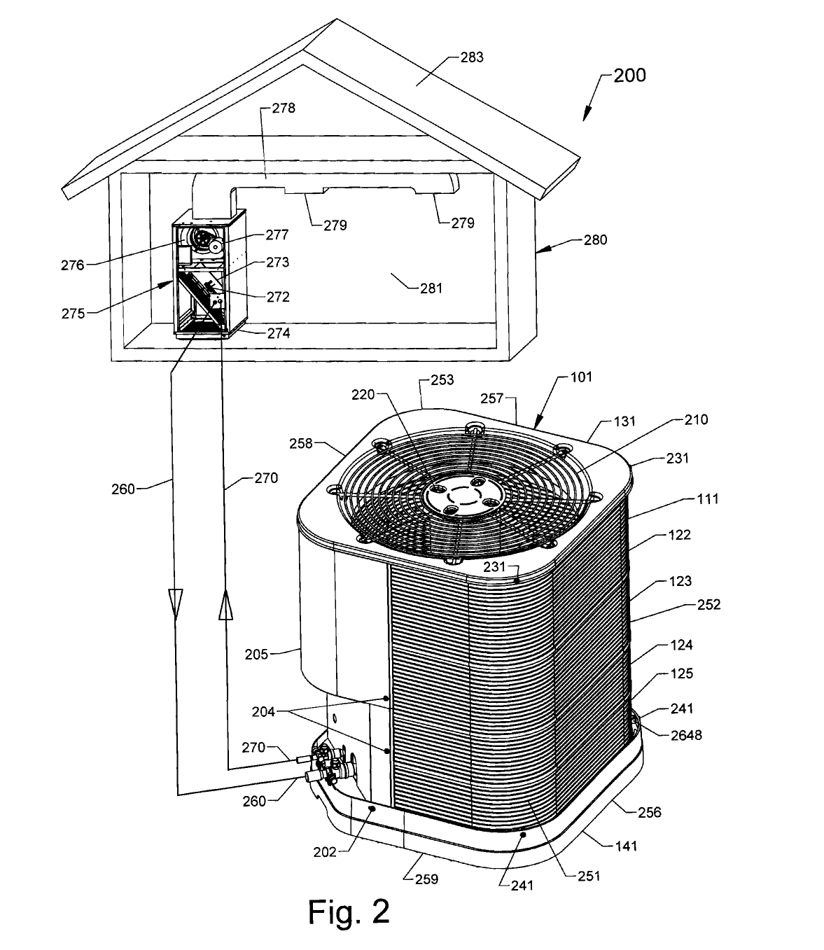

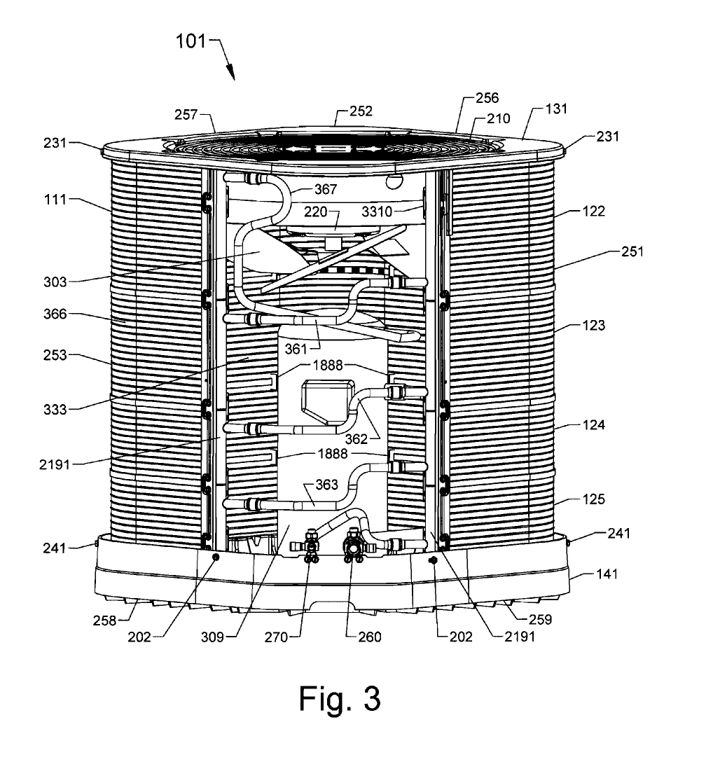

FIG. 2 is a closer view of air conditioning unit 101, also shown in FIG. 1, and FIG. 3 is a back view of air conditioning unit 101 shown with rear panel 205 (shown in FIG. 2) removed. In the embodiment shown, heat exchanger 111 includes bends 251, 252, and 253, at three of the corners of air conditioning unit 101. Bends 251, 252, and 252 may be right-angle bends, or substantially right-angle bends, as examples. As used herein, “right-angle bends” means 90 degree bends, plus or minus one degree, and “substantially right-angle bends” means 90 degree bends, plus or minus five degrees. A fourth corner of air conditioning unit 101 (which also may be a right-angle or a substantially right-angle) is formed by access panel 205, which (e.g., along with base 141 and top section 131), may be plastic or sheet metal, for instance, painted or galvanized (or both) steel, stainless steel, or aluminum, for example. In the embodiment shown, in each air conditioning unit (e.g., 101 or 102) or heat exchanger module (e.g., 111 or 112), the bends (e.g., 251 to 253) occur at corresponding locations in the heat exchanger modules that form the heat exchanger assembly.

In this embodiment, heat exchanger 111 forms essentially all of two sides (256 and 257) of air conditioning unit 101 and more than half of each of the other two sides (258 and 259) of air conditioning unit 101. In other embodiments, on the other hand, the heat exchanger may form all or part of two or three sides of the unit, or in some embodiments, may just be located on one side of the unit. In some embodiments, the heat exchanger may include 0, 1, 2, 3, 4, or another number of bends (e.g., right-angle bends 251, 252, and 253 shown).

In the embodiment illustrated, air enters air conditioning unit 101 from the sides (e.g., 256 to 259) of air conditioning unit 101 through heat exchanger 111, and exits upward through the top 131 of air conditioning unit 101 through exhaust grille 210, although an opposite direction of air flow may be used in some embodiments. Although not shown, in some embodiments, heat exchanger 111 may be covered with a grille, screen, louvered enclosure, expanded metal, plastic or metal mesh, or the like, for instance, to protect heat exchanger 111 from damage, clogging with debris, etc., which may also help to contain noise in some embodiments, provide an improves aesthetic appearance, or protect air conditioning unit 101 from rain or other weather or environmental damage, such as hail.

This air (e.g., outside air) may be moved or blown by a fan (e.g., first fan 303 shown in FIG. 3) which may be positioned below top 131, and in different embodiments, may be mounted from or attached to top 131, heat exchanger 111, bottom 141, or other structure of air conditioning unit 101. Fan 303, in various embodiments, may be supported or suspended by motor (e.g., first electric motor) 220, which may drive fan 303. In the embodiment illustrated, motor 220 is attached to grille 210, which is attached to or part of top 131. As used herein, motor 220 (and fan 303) are said to be “attached” to top (or top housing section) 131 if motor 220 is attached to top 131 directly, through grille 210, or through other components, such that the weight of motor 220 is carried by top 131. These components may be attached to each other with fasteners, such as sheet metal screws, nuts, bolts, rivets, etc.

Motor 220 may be a single-speed alternating current (AC) induction motor, in some embodiments, for example, or may be a variable-speed (e.g., AC or DC) motor, in other embodiments. In the embodiment illustrated, fan 303 is an axial-flow fan, but in other embodiments, a centrifugal (e.g., squirrel cage or forward curved blade, or a backward curved or airfoil shaped blade) fan or mixed flow fan may be used. Although not shown, in some embodiments, (e.g., in a cooling mode) air passing through heat exchanger 111 may be precooled, for instance, via an evaporative cooler (e.g., forming or mounted on top of top 131) or may include exhaust air (e.g., from the space being air conditioned).

Referring to FIG. 2, in the split system embodiment illustrated, air conditioning unit or condensing unit 101 includes or connects to vapor refrigerant line 260, which (e.g., in a cooling mode) delivers low pressure refrigerant vapor from the evaporator 273 within the air handling unit 275, within building 280, to air conditioning unit 101. Building 280 and the components therein are not shown to scale relative to air conditioning unit (condenser) 101 or to each other. In this same example, liquid refrigerant line 270, delivers high pressure liquid refrigerant from air conditioning unit (e.g., condenser) 101 to the evaporator 273. In many embodiments, refrigerant lines 260 and 270 may be different sizes of copper tubing, for example, with vapor line 260 being larger in diameter. In the embodiment illustrated, vapor line 260 delivers refrigerant to compressor 309 (shown in FIG. 3), which compresses the refrigerant before the refrigerant travels to heat exchanger 111. The refrigerant condenses to liquid within heat exchanger 111, before traveling through liquid line 270 to an expansion device (e.g., an expansion valve) 272 and evaporator 273.

In the embodiment illustrated, air conditioning unit 101 (in combination with air handler 275 and other components of air conditioning system 200, such as a thermostat) controls and conditions (i.e., heats, cools, or both) the temperature of space 281 enclosed by building 280. In this embodiment, blower or fan 276, powered by electric motor 277, draws air (return air) through filter 274 from space 281 within building 280, moves the air through evaporator 273 where the air is cooled (in a cooling mode), and delivers the cooled air (supply air) to space 281 through duct work 278 and registers 279. Condenser 101, lines 260 and 270, air handler 275 including filter 274, ductwork 278, and registers 279, and a few other components such as a thermostat (not shown), form air conditioning system 200. Building 280 may be, for example, a single-family residence, a duplex, a triplex, a fourplex, an apartment, a cabin, a business structure, a garage, a restaurant, a store, an office, a bar, a school room, a hotel room, or the like.

In some embodiments, evaporator 273 may be formed from multiple heat exchanger modules, which may be similar to those described herein for heat exchangers that serve as condensers. Motor 277 may be a single-speed AC induction motor, for example, or may be a multiple-speed or variable speed AC or DC motor, in different embodiments. In some embodiments, the air conditioning unit may be a packaged air conditioning unit, and the components of air conditioning unit 101 and air handler 275 may be combined into the same enclosure (e.g., for roof mounting, for instance, on roof 283). In packaged air conditioning units, modular heat exchangers may be used for the condenser, the evaporator, or both, and may be flat or have fewer bends (e.g., 0, 1, or 2 bends) than the heat exchanger modules shown in most of the drawings herein.

In some embodiments, the air conditioning unit may be configured (e.g., with automatic valves and controls) to serve as a heat pump in addition to cooling. In a heat pump mode, the roles of the heat exchangers are reversed, such that the heat exchanger that serves as a condenser in a cooling mode serves as an evaporator in a heating mode, and vice versa. In a number of embodiments, an air handling unit or a packaged air conditioning unit includes another heating source, such as one or more electric heating elements, a gas furnace, or both, for instance.

The refrigerant used in air conditioning unit 101, for example, may be R-410A, AZ-20, PURON, GENETRON R410A, FREON, R-22, R-134a, or the like. Compressor 309 may be a rotary compressor, for example, and may be driven by an electric motor, which may be may be a single-speed alternating current (AC) induction motor, in some embodiments, for example, or may be a variable-speed (e.g., AC or DC) motor, in other embodiments. Compressor 309 may be supported by, attached to, or mounted on base 141. In various embodiments, the motor for compressor 309 may also (or instead) be mounted on base 141, or may be internal or integral with compressor 309. In some embodiments, an air conditioning unit may include more than one compressor (e.g., mounted on its base structure) which may be different sizes or capacities for different load conditions. Different size or capacity air conditioning units (e.g., unit 102 shown in FIG. 1) may have different size or capacity compressors, fans, motors, refrigerant lines, etc.

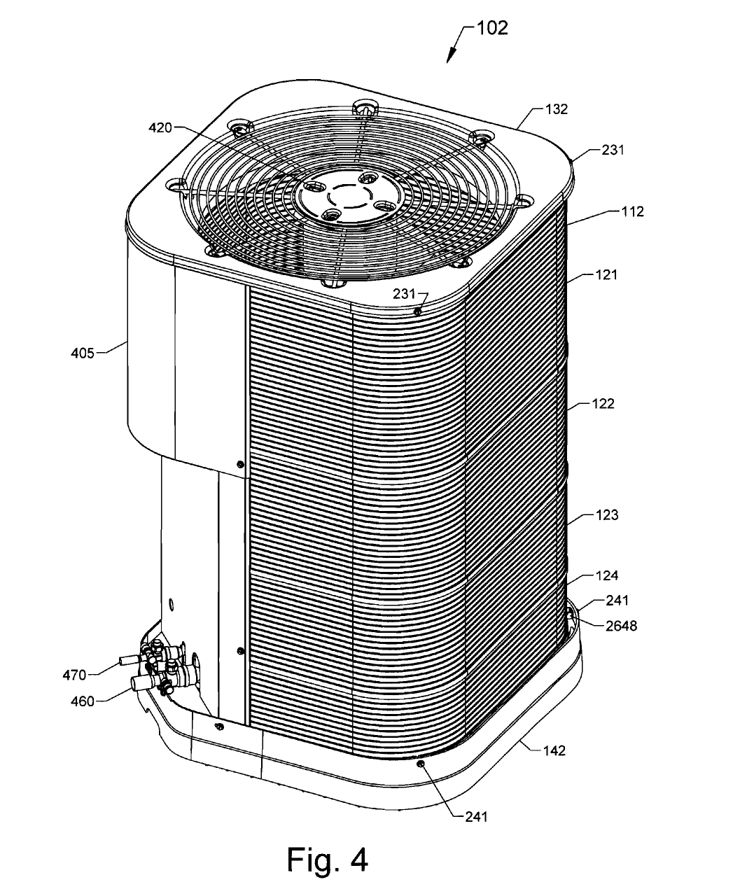

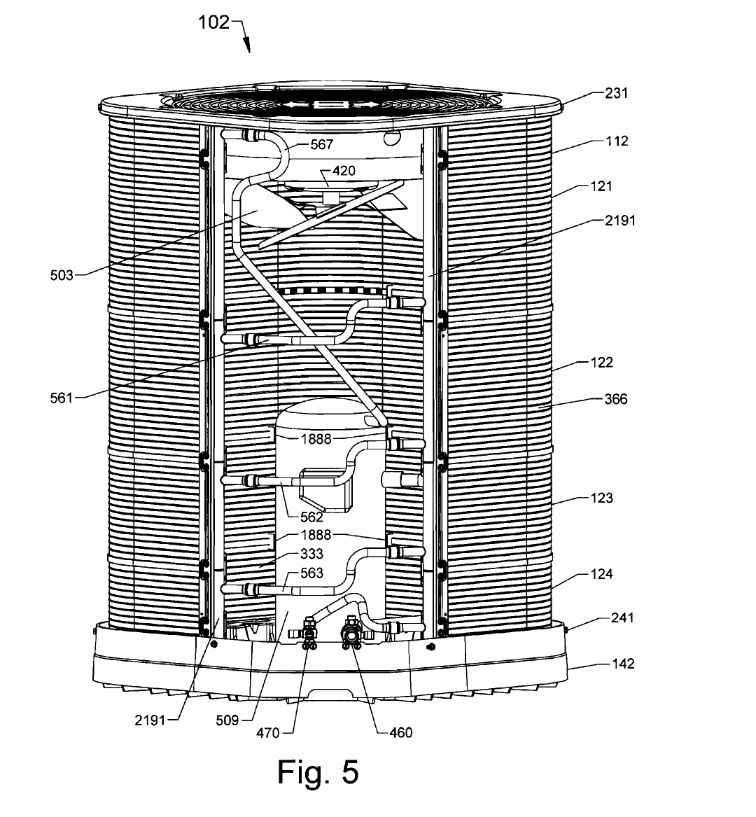

FIGS. 4 and 5 are closer views of air conditioning unit 102 shown in FIG. 1. Air conditioning unit 102 may be similar to air conditioning unit 101 except with respect to size, capacity, which modules in contains, or as described herein. Air conditioning unit 102 includes vapor refrigerant line 460, liquid refrigerant line 470, rear panel 405 (removed in FIG. 5), condenser fan 503, condenser fan motor 420, and compressor 509, which, in different embodiments, may be similar to or different from analogous components previously described for air conditioning unit 101.

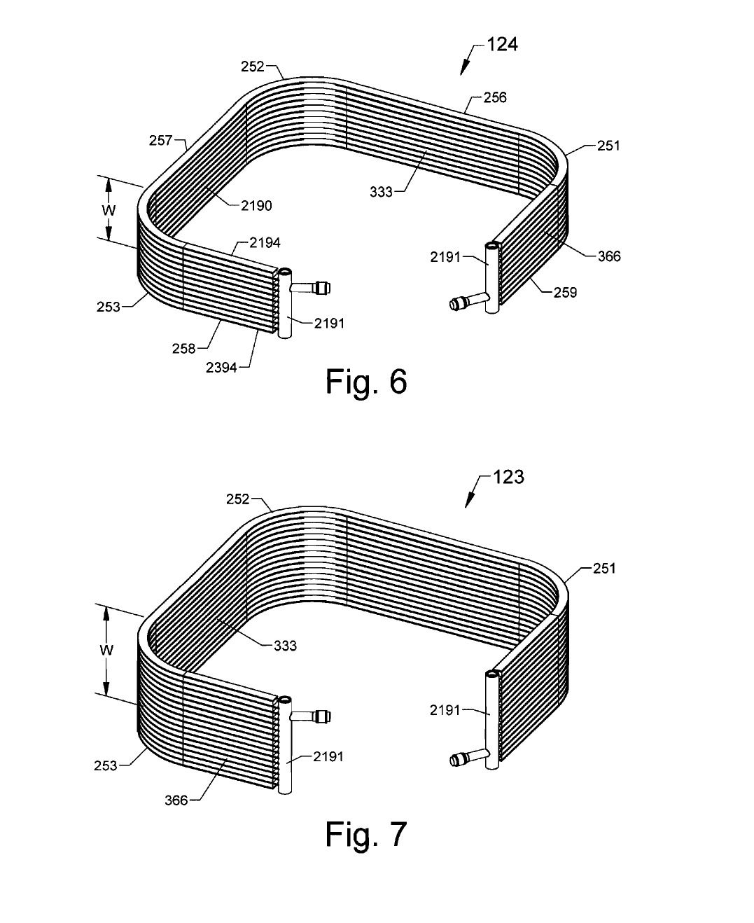

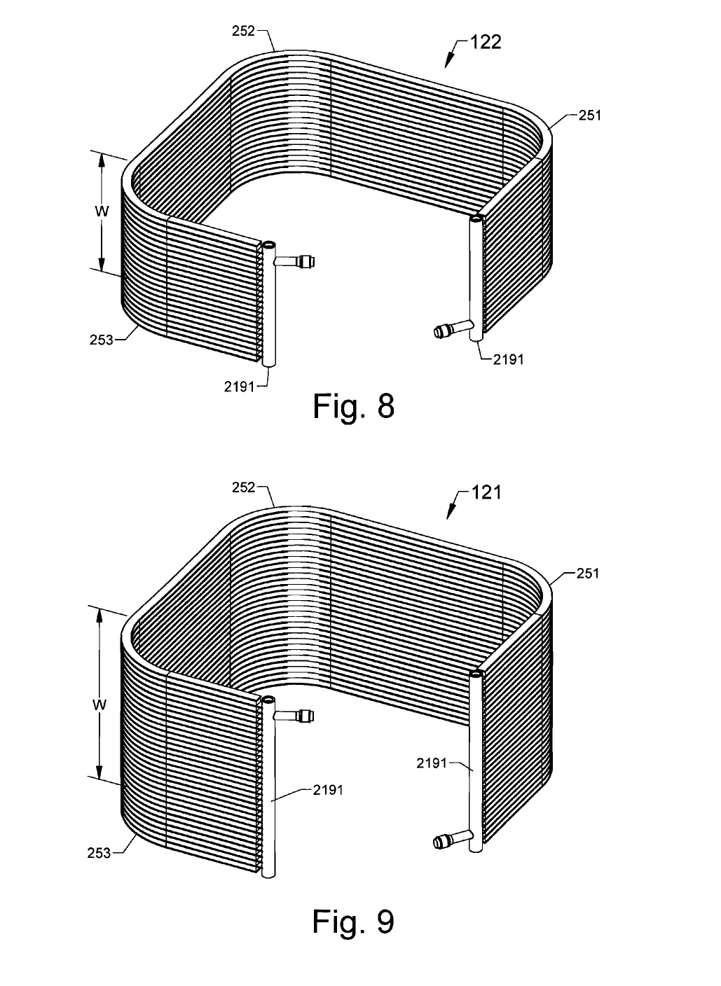

As mentioned, in various embodiments, heat exchangers (assemblies) 111 and 112 in air conditioning units 101 and 102 are formed from various combinations of modules 121 to 125, for instance. Other embodiments of air conditioning units can be formed from different combinations of these or other heat exchanger modules. FIGS. 6 to 9 show modules 121 to 124 individually. In the embodiment illustrated, module 125 is the same as module 124, although in other embodiments, such modules may differ. Each of modules 121 to 124 have a different width (w). As used herein, “width” of a heat exchanger means the dimension in the direction that is perpendicular to the direction of the flow of air (at the heat exchanger) and perpendicular to the direction of flow of refrigerant (through the heat exchanger). In the embodiment shown, width (w) is in the vertical direction.

In this embodiment, each of heat exchangers 121 to 125 includes three right-angle bends 251, 252, and 253, between sides 256 to 259 (labeled in FIG. 6), although other embodiments may have a different number (or no) bends, or may have bends at a different angle or radius of curvature. In some embodiments, the modules form part of a circle, ellipse, or oval, or are one continuous bend or arc, for example and have no straight sides (e.g., 256 to 259). Other embodiments may have corners that do not use radiused bends, but rather have sharp bends, headers, fittings, mitered joints, or the like.

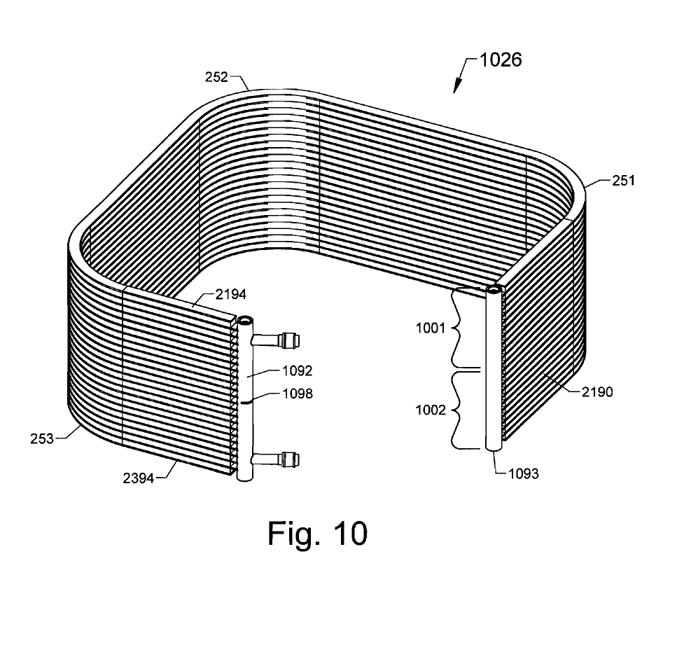

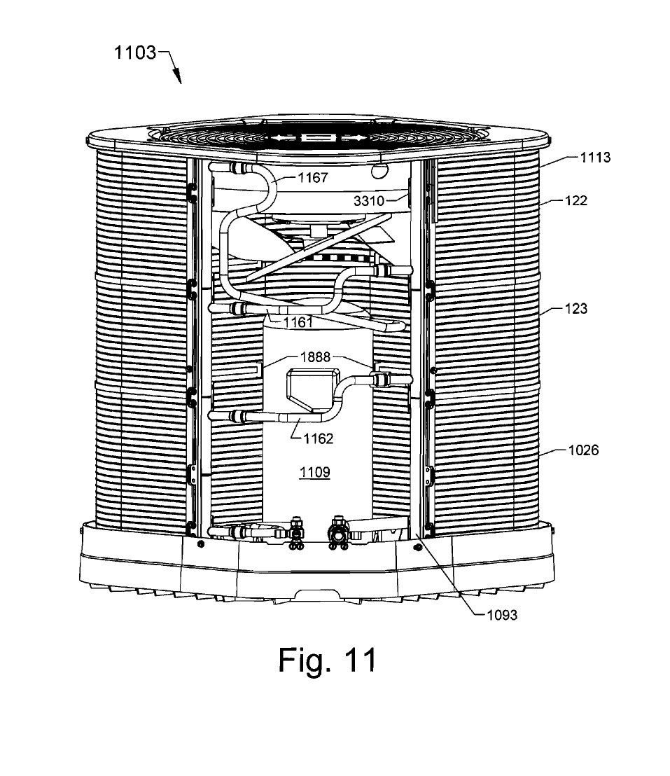

In the embodiments illustrated in FIGS. 6 to 9, each module 121 to 124 forms a single stage or pass for the refrigerant across or around the heat exchanger (e.g., 111 or 112) or air conditioning unit (e.g., 101 or 102). FIG. 10 illustrates a different embodiment, module 1020, that forms two stages or passes for the refrigerant across or around the heat exchanger or air conditioning unit. FIG. 11 illustrates an example of such an air conditioning unit, namely, air conditioning unit 1103, which includes heat exchanger (assembly) 1113, which includes heat exchanger modules 122, 123, and 1026. Air conditioning unit 1103 may be a 2.5 ton unit, for example, and may be similar to air conditioning unit 101, except where described otherwise.

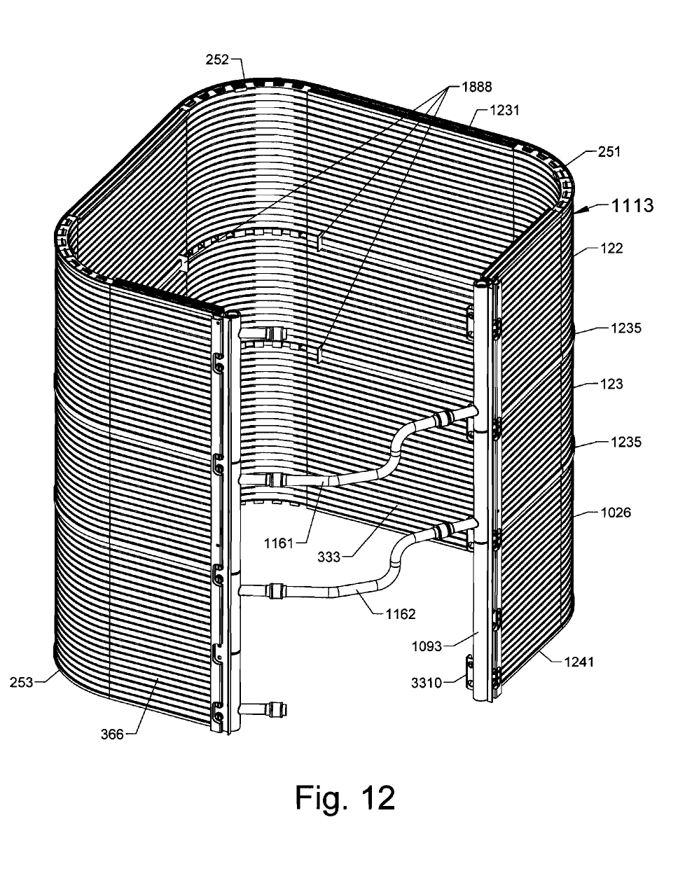

FIG. 12 shows heat exchanger 1113 individually, as an assembly.

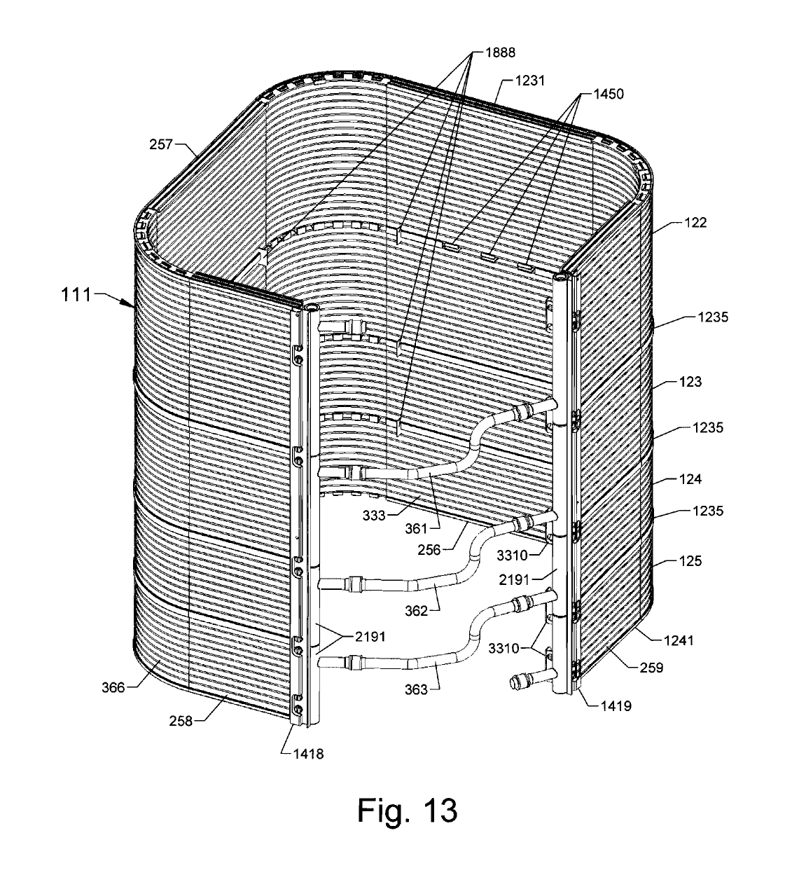

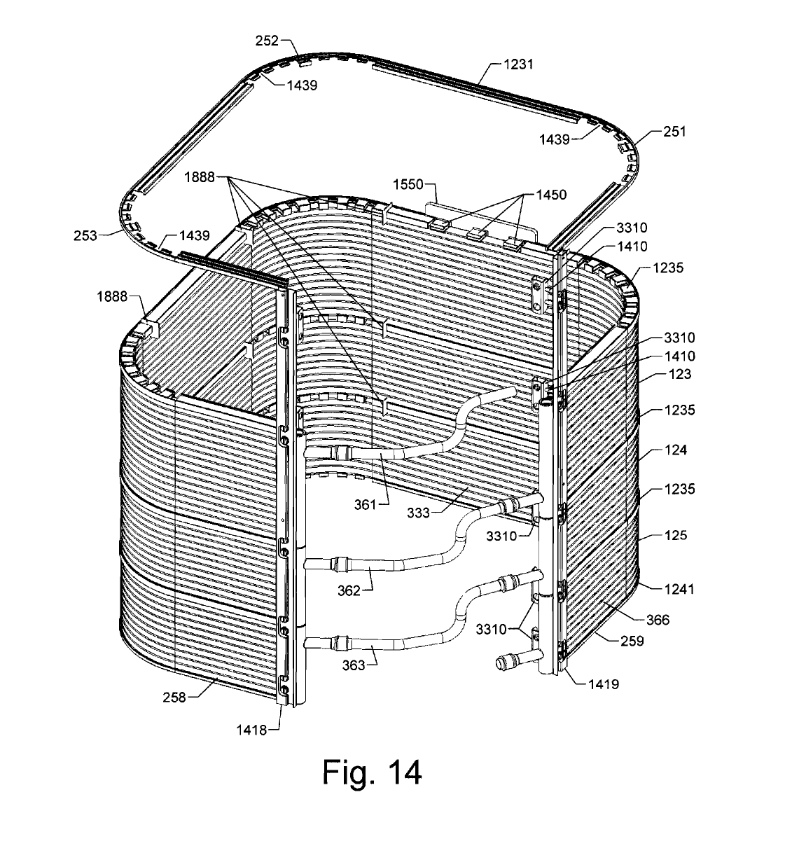

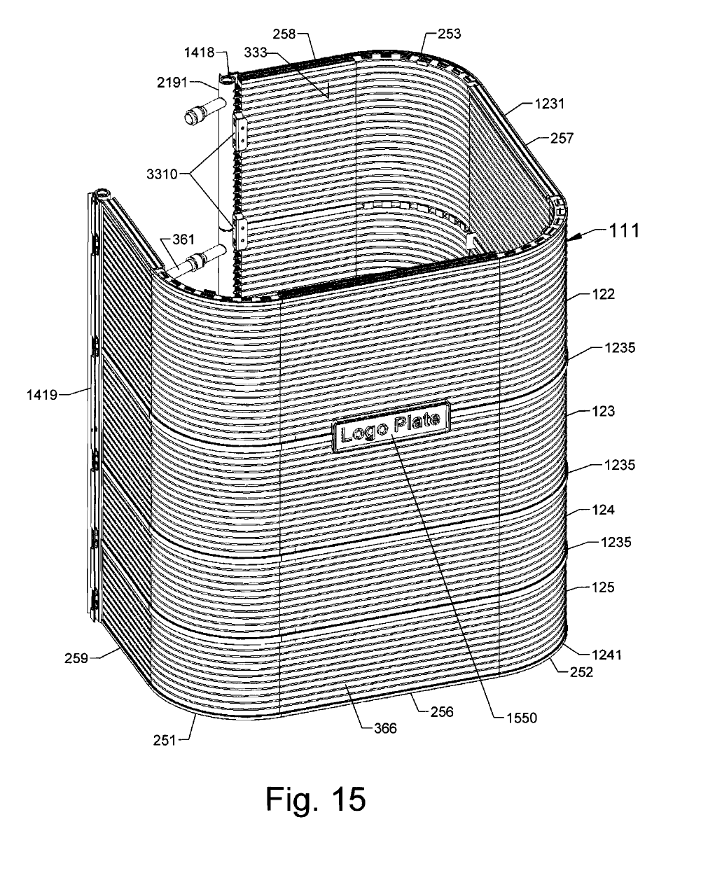

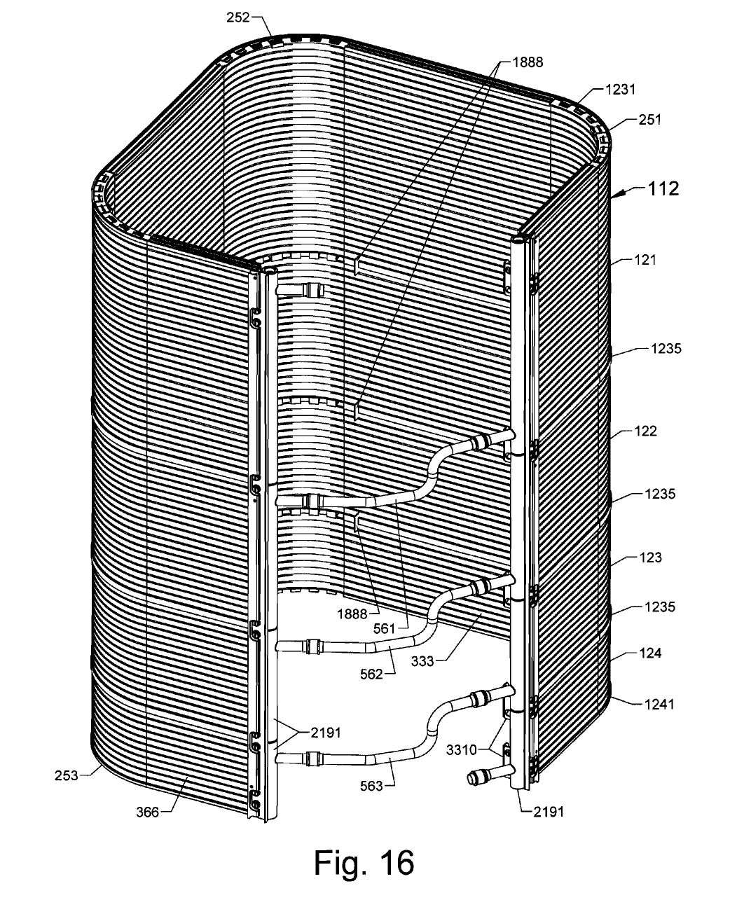

Similarly, FIG. 13 shows heat exchanger 111 individually, as an assembly, and FIG. 14 shows heat exchanger 111 (of air conditioning unit 101) as an assembly, except that the top module 122 is omitted. FIG. 15 shows heat exchanger 111 from a different angle, showing the front, and FIG. 16 shows heat exchanger 112 (of air conditioning unit 102) as an assembly, from the rear. These, and the other figures illustrate various examples of different embodiments, but are not intended to be limiting. Other embodiments of air conditioning units or heat exchanger assemblies may have different combinations of these modules, or other modules with different relative dimensions or numbers of passes, as examples.

FIGS. 12 to 16 illustrate (in more detail than the previous figures) that in many embodiments, spacers are provided between the modules, on one or both sides (e.g., above and below) of the heat exchanger assembly, or a combination thereof. For instance, in the embodiment illustrated, spacers 1235 are provided between heat exchanger modules (e.g., between modules 122 and 123 and between modules 123 and 1026 shown in FIG. 12), spacer 1241 is provided below heat exchanger assembly 1113 (e.g., below module 1026), and spacer 1231 is provided above heat exchanger assembly 1113 (e.g., above module 122). In various embodiments, different size or configurations of air conditioning units or heat exchanger assemblies may have the same or different spacers. In the embodiments illustrated, the same spacers 1231, 1235, and 1241 are shown (e.g., in heat exchanger assemblies 111 and 112 shown in FIGS. 13, 15, and 16).

In a number of embodiments, spacer 1241 (below the heat exchanger assembly) and spacer 1231 (above the heat exchanger assembly) are the same, or have the same cross section, except may be oriented with the opposite side up. In other embodiments, spacer 1241 (below the heat exchanger assembly) and spacer 1231 (above the heat exchanger assembly) are different or have different cross sections. For example, in some embodiments, spacer 1241 (below the heat exchanger assembly) may be configured to support more weight than spacer 1231 (above the heat exchanger assembly). In certain embodiments, spacer 1241 (below the heat exchanger assembly), spacer 1231 (above the heat exchanger assembly), and spacer 1235 (between the heat exchanger modules) are all the same, or all have the same cross section.

In many embodiments, spacer 1241 (below the heat exchanger assembly), spacer 1231 (above the heat exchanger assembly), spacer 1235 (between the heat exchanger modules), or a combination thereof, are extruded. Some or all of these spacers (e.g., 1231, 1235, and 1241) may consist essentially of an extruded piece of material, may be made of plastic or aluminum, for example, and may (e.g., in the embodiment illustrated, for instance, in FIG. 14) contain cut-outs or cuts 1439 to provide for (e.g., make the spacers more flexible) for bending (e.g., at particular locations which may correspond to bends or corners 251, 252, and 253 of the heat exchanger assembly or air conditioning unit). In certain embodiments, some or all of the spacers (e.g., 1231, 1235, and 1241) may be formed or ornamented to simulate fins, to give the air conditioning unit or heat exchanger assembly a more-uniform overall appearance.

In many embodiments, the spacers (e.g., 1231, 1235, and 1241) may attach the heat exchanger modules together to form the heat exchanger assembly (e.g., alone or in combination with other structural components, refrigerant conduits, or both), may serve to maintain a certain distance between modules or between the heat exchanger assembly and other components (e.g., base 141), may serve to keep the modules lined up (e.g., in a horizontal direction), with each other (e.g., spacer 1235) or with other components (e.g., spacers 1231, 1241, or both) may block the flow of air between (e.g., spacers 1235) or around (e.g., spacers 1231, 1241, or both) the modules, may reduce heat transfer between modules (e.g., spacers 1235), may improve the appearance of the heat exchanger assembly or air conditioning unit, or a combination thereof, as examples. In some embodiments, for example, spacers 1235 may be configured to significantly reduce the amount of air that passes between the heat exchanger module above the spacer and the heat exchanger module below the spacer. As used herein, such a flow is significantly reduced if the amount of air that passes between the two modules (excluding air that passes through the modules, for instance, between the fins) is reduced by at least 80 percent. In a number of embodiments, some or all of the spacers (e.g., 1231, 1235, and 1241) may attach to the heat exchanger modules, for instance, with a snap fit, an interference fit, an adhesive, fasteners, clips, or the like, or a combination thereof.

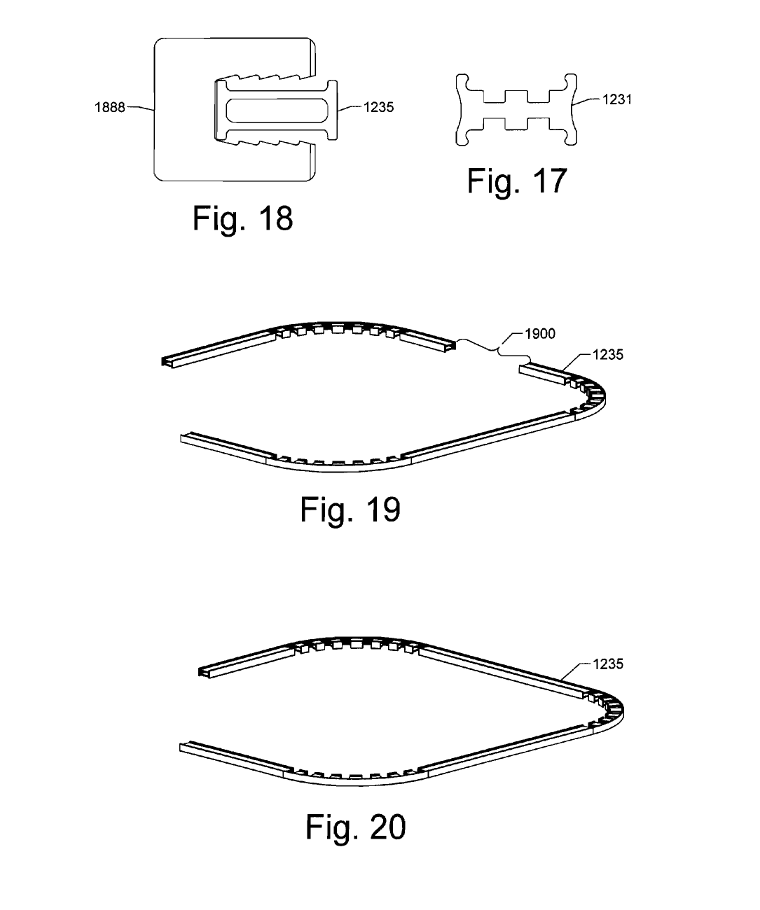

Some or all of these spacers (e.g., 1231, 1235, and 1241) may have a hollow cross section, may have a cross section of a single or double I-beam, or the like. FIG. 17 illustrates a close-up view of an example of a cross section of spacer 1231, a modified single I-beam shape. FIG. 18 illustrates an alternate shape of a spacer, spacer 1235, which is a hollow extrusion that has a double I-beam shape. FIGS. 19 and 20 illustrate examples of embodiments of spacer 1235.

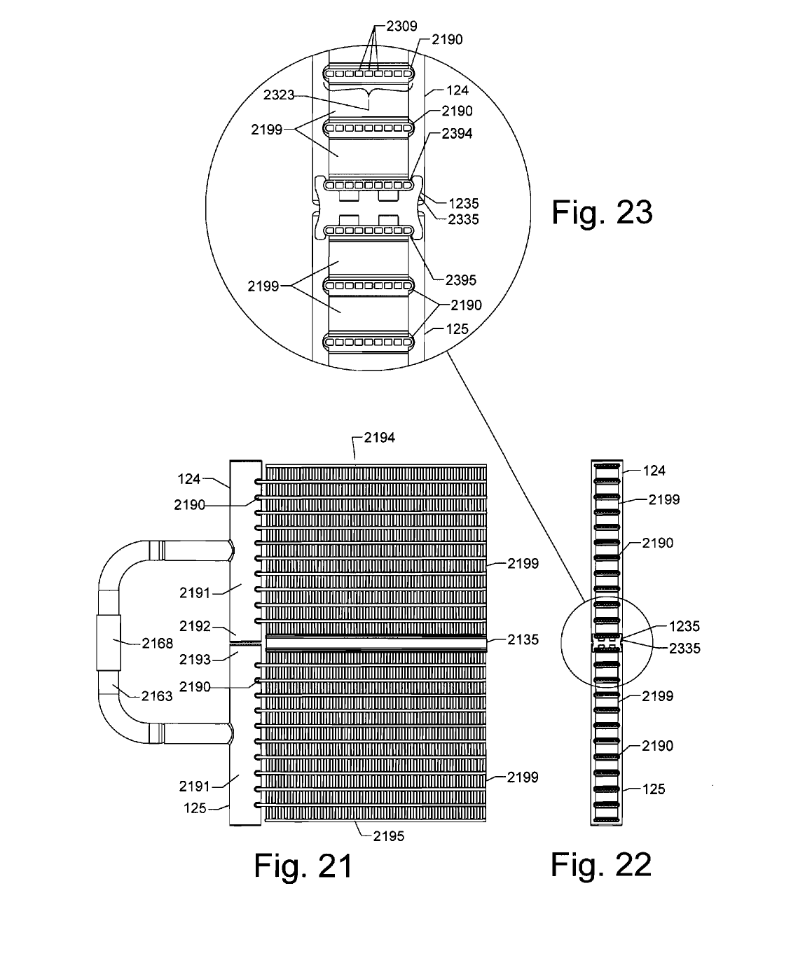

In a number of embodiments, heat exchangers described herein are micro-channel or microchannel heat exchangers, for example. Other embodiments are tube and fin heat exchangers, as another example. FIG. 21 is a closer view of the ends of two heat exchanger modules, specifically modules 124 and 125 (e.g., at side 259 of heat exchanger 111 of air conditioning unit 101, shown in FIGS. 2, 3 and 13). Heat exchanger modules 124 and 125 may be interchangeable, in this embodiment, and each contain ten (10) active tubes or multi-tubes 2190 connected to (refrigerant) headers 2191 at each end (one end is shown in FIG. 21, but both ends are shown in FIG. 6) of the heat exchanger modules (e.g., 124 and 125). As used herein, “connected” or “connected to”, at least when referring to tubing or a closed fluid (e.g., refrigerant) conduit, means attached or joined in a manner that forms a closed fluid passageway through the tubing or fluid conduit (e.g., multi-tube 2190) to an interior space of the component (e.g., header 2191) to which it is connected. In contrast, as used herein, “attached” includes structural joints not configured to form a fluid (e.g., refrigerant) passageway.

A spacer 1235 is shown between heat exchanger modules 124 and 125 in FIG. 21. FIG. 22 is a cross sectional view through heat exchanger modules 124 and 125 and spacer 1235 of FIG. 21, and FIG. 23 is a detail view of the center of FIG. 22, showing spacer 1235 in more detail. A different embodiment of spacer 1235 is shown in FIGS. 21 to 23, spacer 2335, the cross section of which is shown best in FIG. 23. In the embodiment illustrated, spacer 2335 has a similar, or the same, cross-sectional shape as spacer 1231 shown in FIG. 17, and snaps onto the bottom multi-tube 2394 of module 124 and the top multi-tube 2395 of module 125, providing horizontal alignment and a limited amount of resistance to forces tending to separate modules 124 and 125. Spacer 2335 also maintains a minimum spacing (e.g., the size of spacer 2335 between multi-tubes 2394 and 2395 of modules 124 and 125, in the embodiment illustrated.

In a number of embodiments, each tube or multi-tube (e.g., 2190 of a heat exchanger module (e.g., modules 124 and 125 shown in FIG. 21) is connected to the header (e.g., 2191) except for the top and bottom multi-tube of each module (e.g., top multi-tube 2194 and bottom multi-tube 2394 of module 124, and top multi-tube 2195 and bottom multi-tube 2395 of module 125). In various embodiments, the top and bottom multi-tubes (e.g., top multi-tube 2194 and bottom multi-tube 2394 of module 124, and top multi-tube 2195 and bottom multi-tube 2395 of module 125) are not connected to the headers (e.g., 2191) for passage of the refrigerant, or at all (as shown, for example, in FIG. 21 for multi-tubes 2194 and 2195).

In many embodiments, fins 2199 are provided between the multi-tubes (e.g., between top multi-tube 2194 and an interior active multi-tube 2190, between bottom multi-tube 2394 and a multi-tube 2190, and between top multi-tube 2195 and a multi-tube 2190, and between bottom multi-tube 2395 and a multi-tube 2190, as well as between adjacent multi-tubes 2190). Fins 2199 may be formed from a strip of sheet metal that is bent back and forth and bonded to the multi-tubes (e.g., 2190). As used herein, “bonded” when referring to fins of a heat exchanger, means attached in a manner that facilitates heat transfer to or from the fins, including, as examples, soldering, welding, being made from a common piece of metal, firm physical contact, etc. In addition, as used herein, although fins 2199 may be formed from the same piece of metal that is bent back and forth, each section extending from the multi-tube (e.g., 2190) is considered to be a separate fin (e.g., 2199). In some embodiments, fins may be enhanced, and may have louvers, perforations, corrugations, rough surfaces, or the like, (e.g., to improve heat transfer to the air).

In various embodiments, inactive multi-tubes (e.g., 2194, 2394, 2395, and 2195) are provided at the top and bottom of the heat exchanger modules (e.g., 124 and 125) so that each active multi-tube 2190 has fins 2199 on both sides to facilitate adequate heat transfer from each active multi-tube 2190. In some embodiments, the inactive multi-tubes (e.g., 2194, 2394, 2395, and 2195) may also help to protect the module from damage. Specifically, if one of the inactive multi-tubes (e.g., 2194, 2394, 2395, and 2195) is punctured, for instance, if heat exchanger module 124 or 125 is bumped on its top or bottom, then the module would not leak refrigerant. In some embodiments, the inactive multi-tubes (e.g., 2194, 2394, 2395, and 2195) may also (or instead) take up space to prevent the headers 2191 (e.g., of modules 124 and 125 shown in FIG. 21) from interfering with each other.

As shown in FIG. 23, each of the multi-tubes (e.g., 2190, 2394, and 2395 shown in FIG. 23) includes multiple (e.g., nine shown) contiguous parallel refrigerant passageways 2309 arranged in row 2323. These passageways 2309 are parallel, meaning geometrically parallel, because passageways 2309 maintain the same distance between them across the heat exchanger module. Further, passageways 2309 are parallel because in the view of FIG. 23, they all extend into and out of the page. In the embodiment illustrated, refrigerant passageways 2309 in a particular multi-tube are also “arranged in” or “connected in” parallel, meaning the refrigerant is divided between the passageways 2309 so that each bit of refrigerant passes through just one passageway 2309 in the particular multi-tube 2190 (in that particular cycle through the air conditioning unit, for instance, 101), as opposed to being arranged in series with respect to the flow of the refrigerant.

These passageways 2309 are contiguous because they have at least one side wall in common (with another refrigerant passageway 2309) along their length. Further, passageways 2309 form a row 2323 because, when viewed in the cross section of FIG. 23, the passageways 2309 are in a straight line (although a curved line would also form a row, as long as it is clearly recognizable as linear). In the embodiment illustrated in FIG. 23, the row 2323 formed by the passageways 2309 of each multi-channel (e.g., 2190) is horizontal or substantially horizontal, and row 2323 is parallel or substantially parallel to the direction of airflow at that multi-tube 2190 (e.g., through fins 2199 adjacent thereto. In other embodiments, the fluid passageways may form multiple rows, for example, two rows, which may be parallel rows, for instance.

Referring to FIGS. 6 and 21, in the embodiment illustrated, each of the multi-tubes (e.g., 2190, 2194, and 2394 in module 124) are parallel to each other geometrically and multi-tubes 2190 are arranged in or connected in parallel with respect to the flow of refrigerant (e.g., from header 2191 on one end of the module to header 2191 on the other end of the module).

In each of air conditioning units 101, 102, and 1103, for example, in heat exchanger assemblies 111, 112, and 1113, the heat exchanger modules (i.e., different combinations of modules 121 to 125 and 1026) the modules are arranged in parallel with respect to air (e.g., outside air) that passes through the heat exchanger assembly. As used herein, “arranged in parallel”, or “connected in parallel” with respect to a fluid, when describing the arrangement of heat exchanger modules, means that the fluid is divided between the modules so that a portion of the fluid (e.g., air) passes through just one of the group of modules, and essentially none of the fluid passes through more than one of the modules (at least on that pass through the heat exchanger assembly), as opposed to being arranged in series with respect to the fluid, wherein the same fluid would pass through multiple modules in the same pass through the heat exchanger assembly. “Arranged in parallel”, with respect to a fluid, when describing the arrangement of heat exchanger modules, does not mean that the heat exchanger module is oriented in any particular direction (e.g., geometrically parallel) relative to the direction of flow of the fluid or other modules, for example.

However, in the embodiments illustrated, the flow of the refrigerant in the different refrigerant passageways 2309, in the different multi-tubes 2190, and in the different heat exchanger modules (e.g., the illustrated combinations of modules 121 to 125 and 1026), the direction of the flow of the refrigerant is (geometrically) parallel to the other passageways, multi-tubes, and modules (e.g., around the circumference of the units or heat exchangers. Other embodiments may differ in this respect.

In various embodiments, connecting refrigerant conduit is provided between different modules in a heat exchanger assembly, as well as between the heat exchanger assembly and different components such as a compressor. Such connecting refrigerant conduit may be pipe or tubing, for example. Referring to FIGS. 3 and 13 to 15, in heat exchanger 111 of air conditioning unit 101, connecting refrigerant conduit or tubing 361 connects heat exchanger module 122 to heat exchanger module 123, connecting refrigerant conduit or tubing 362 connects heat exchanger module 123 to heat exchanger module 124, and connecting refrigerant conduit or tubing 363 connects heat exchanger module 124 to heat exchanger module 125. Further, connecting refrigerant conduit or tubing 367 connects heat exchanger module 122, and heat exchanger assembly 111, to compressor 309.

Similarly, referring to FIGS. 5 and 16, in heat exchanger 112 of air conditioning unit 102, connecting refrigerant conduit or tubing 561 connects heat exchanger module 121 to heat exchanger module 122, connecting refrigerant conduit or tubing 562 connects heat exchanger module 122 to heat exchanger module 123, and connecting refrigerant conduit or tubing 563 connects heat exchanger module 123 to heat exchanger module 124. Further, connecting refrigerant conduit or tubing 567 connects heat exchanger module 121, and heat exchanger assembly 112, to compressor 509. Moreover, referring to FIGS. 11 and 12, in heat exchanger 1113 of air conditioning unit 1103, connecting refrigerant conduit or tubing 1161 connects heat exchanger module 122 to heat exchanger module 123, connecting refrigerant conduit or tubing 1162 connects heat exchanger module 123 to heat exchanger module 1026, and connecting refrigerant conduit or tubing 1167 connects heat exchanger module 122, and heat exchanger assembly 1113, to compressor 1109. (In some embodiments, compressor 1109 and 309 may be similar or interchangeable.)

In some embodiments, the connecting refrigerant conduit or tubing between modules (e.g., 361 to 363 and 561 to 563 shown in FIGS. 3, 5, and 13 to 16) may be arranged (e.g., across the back of the unit) so that the refrigerant travels in the same direction in each heat exchanger module of the heat exchanger assembly (e.g., 111 and 112). In other embodiments, the connecting refrigerant conduit or tubing between heat exchanger modules (e.g., 2163 shown in FIG. 21) may reverse the direction of refrigerant flow (e.g., in adjacent modules 124 and 125). Although not illustrated, in some embodiments, the headers (e.g., 2191) may connect to each other rather than having a separate section of refrigerant conduit or tubing between the modules. For example, in FIG. 21, instead of tubing 2163, in some embodiments, bottom end 2192 of header 2191 of heat exchanger module 124 may connect to top end 2193 of header 2191 of heat exchanger module 125, for instance, with a male and female, bell and spigot, o-ring seal, set of flanges, union, coupling, or the like.

In the embodiment illustrated in FIGS. 10 to 12, the refrigerant reverses direction within module 1026, traveling in the opposite direction in the top half 1001, than in the bottom half 1002 of module 1026, reversing direction in header 1093. In this embodiment, header 1092 includes a partition 1098 between the top half 1001 and the bottom half 1002 of module 1026. In the embodiment illustrated, each of the top half 1001 and the bottom half 1002 of module 1026 includes 11 active multi-tubes 2190 connected in parallel through headers 1092 and 1093. Other embodiments may have different numbers of active multi-tubes 2190, different numbers of passes, or both. Module 1026 also has inactive top and bottom multi-tubes 2194 and 2394 which are not connected to the headers (e.g., 1092 and 1093) for passage of the refrigerant, or directly attached to the headers at all.

In comparison with heat exchanger modules 124 and 125 of heat exchanger assembly 111 of air conditioning unit 101, heat exchanger module 1026 of heat exchanger assembly 1113 of air conditioning unit 1103 has the same number (24) of multi-tubes (both active multi-tubes 2190 and inactive multi-tubes (e.g., 2194, 2195, 2394, and 2395). However, heat exchanger module 1026 has one more (11 instead of 10) active multi-tubes 2190 in each pass, when compared with the two modules 124 and 125. This is because heat exchanger module 1026 only has two inactive multi-tubes, 2194 and 2394, in comparison with the total of four inactive multi-tubes (e.g., 2194, 2195, 2394, and 2395) of heat exchangers 124 and 125 combined.

However, heat exchanger module 1026 may have more undesirable heat transfer between one pass (e.g., top half 1001) and the other pass (e.g., bottom half 1002) through fins 2199, particularly at the end of heat exchanger module 1026 near header 1092, which may cause entropy production. This increase in heat transfer between passes is because spacer 1235 between heat exchanger modules 124 and 125 may reduce conductive heat transfer between the modules (e.g., especially if spacer 1235 is made of a non-metal such as plastic) in comparison with (e.g., aluminum) fins 2199. Heat transfer may also occur through partition 1098 in header 1092, and through the walls of header 1092. In addition, because the flow of refrigerant in heat exchanger modules 124 and 125 is in the same direction, the peak difference in temperature between the two passes is reduced (e.g., in comparison with the two passes of heat exchanger module 1026 at the end having header 1092).

In the embodiment illustrated in FIGS. 3, 5, and 11 to 16, (and 21 to the extent shown), the heat exchanger modules (e.g., 121 to 125 and 1026) are arranged (i.e., connected) in series with respect to the refrigerant that passes through the heat exchanger assembly (e.g., 111, 112, or 1113). Each heat exchanger module forms at least one complete pass across the heat exchanger module, and each heat exchanger module forms at least one different pass of the heat exchanger assembly. Specifically, in the embodiments illustrated, heat exchanger modules 121 to 125 each form one complete pass across the heat exchanger module (e.g., 111 or 112), and heat exchanger module 1026 forms two complete passes across heat exchanger module 1113. In other embodiments, heat exchanger modules may form more than two passes, for example, 3, 4, 5, 6, 7, 8, 9, or 10 complete passes. In some embodiments, the heat exchanger modules may be arranged (i.e., connected) in parallel with respect to the refrigerant that passes through the heat exchanger assembly. In such embodiments, the different modules may each have more passes, and may have fewer active multi-tubes (e.g., 2190) in each pass.

In many embodiments, the heat exchanger assemblies (e.g., 121 to 125 and 1126, some or all of which are shown in FIGS. 6 to 10) are made, in whole or in part, of aluminum (e.g., an aluminum alloy). In a number of embodiments, the connecting refrigerant conduit or tubing between modules (e.g., 361 to 363 and 561 to 563 shown in FIGS. 3, 5, and 13 to 16, 1161 and 1162 shown in FIGS. 11 and 12, and 2163 shown in FIG. 21) includes a section of copper tubing. Such a section of copper tubing facilitates being able to replace one heat exchanger module in the field, for example, if the heat exchanger module is damaged, becomes clogged, or springs a leak (e.g., without replacing the other heat exchanger modules). In the embodiments illustrated, the components shown in FIGS. 6 to 10 may be aluminum, while the sections of tubing labeled 260, 270, 361 to 363, 367, 460, 470, 561 to 563, 567, 1161, 1162, 1167, and 2163 may be copper (e.g., soft or rigid copper tubing of a standard size).

In different embodiments, the copper may be connected to the aluminum by welding, such as resistance welding (e.g., in the factory), or with a mechanical joint such as the use of a compression ring (e.g., a LOKRING). Other embodiments may form this connection between copper and aluminum using pipe threads, o-ring fittings, flanges, unions, couplings, an interference fit, an adhesive, or the like, as other examples. Sections of copper tubing may be brazed or soldered, for example, between different heat exchanger modules, or between the heat exchanger assembly and different components. Such brazing or soldering may be performed, for instance, at couplings, elbows, or other fittings, such as coupling 2168 shown in FIG. 21.

As shown in FIGS. 1 to 16, in many embodiments, different heat exchanger modules have at least one dimension or overall dimension, such as width, that is significantly different for different modules. In the embodiment illustrated, the modules have the same size and spacing of the multi-tubes (e.g., 2190) and the same size fins 2199, but the different modules have different (e.g., significantly different) numbers of active multi-tubes 2190. Referring to FIGS. 6 to 9, heat exchanger module 124 (and, in a number of embodiments, also module 125) have 10 active multi-tubes 2190, heat exchanger module 123 has 15 active multi-tubes 2190, heat exchanger module 122 has 20 active multi-tubes 2190, and heat exchanger module 121 has 30 active multi-tubes 2190. Each of these heat exchanger modules also has two inactive multi-tubes (e.g., 2194 and 2394 shown on the top and bottom for module 124 in FIG. 6). Referring to FIG. 10, heat exchanger module 1026 has 22 active multi-tubes 2190 (in two passes of 11 each) and two inactive multi-tubes 2194 and 2394.

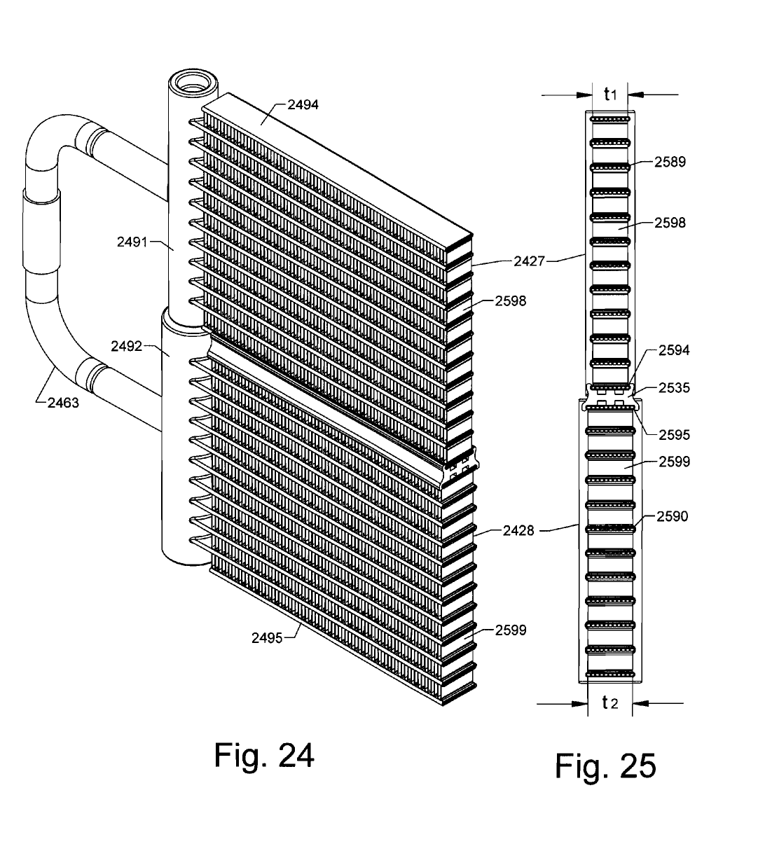

Other embodiments may have different numbers of multi-tubes or active multi-tubes in different size heat exchanger modules or may vary other parameters resulting in at least one differing dimension of the different modules. FIGS. 24 and 25 illustrate an alternate embodiment in which different modules 2427 and 2428 used in the same heat exchanger assembly (only part of which may be shown), and connected in series with refrigerant conduit or tubing 2463, have differing thicknesses t₁ and t₂. These differing thicknesses t₁ and t₂ correspond, in the embodiment shown, to different size multi-tubes (e.g., active multi-tubes 2589 and 2590, respectively being connected in parallel via headers 2491 and 2492, and inactive multi-tubes 2494, 2495, 2594, and 2595) and different size fins 2598 and 2599. Spacer 2535 may be similar to other spacers described herein, except for the shape which differs to accommodate the differing thicknesses t₁ and t₂ or differing size multi-tubes (e.g., inactive multi-tubes 2594, and 2595). Thicknesses t₁ and t₂ may be, for example, between 518 and 1-inch, for example, or between ½ and 1 ½ inches, in different embodiments. In other words, the multi-tubes described herein may have such a thickness (e.g., in the direction of air flow). The multi-tubes described herein may have a width (e.g., in the direction of w shown in FIGS. 6 to 10) between ⅛ and 1/16 inch, for example.

In the embodiments illustrated, the air conditioning units (e.g., 101, 102, and 1103) are condensing units (at least when in a cooling mode), and refrigerant passing through them enters as a gas, and exits as a liquid, having a much lower volume. In some embodiments, for example, the refrigerant leaves the condensing unit (e.g., 101) as a subcooled liquid, for instance, with about 8 degrees F. of subcooling. Due to the decrease in volume (i.e., increase in density), as the refrigerant condenses, the total cross sectional area of the flow passages for the refrigerant can decrease as the refrigerant moves through the heat exchanger assembly and the refrigerant condenses, without causing excessive pressure drop through the later passes of the heat exchanger assembly. This is accomplished in air conditioning units 101, 102, and 1103 by reducing the number of active multi-tubes 2190 connected in parallel in each successive (i.e., connected in series) heat exchanger module or pass, for example.

In the example of air conditioning unit 102, shown in FIGS. 4 and 5, having heat exchanger modules shown in FIGS. 6 to 9, for instance, hot refrigerant gas or vapor leaves compressor 509 and travels through tubing 567 to heat exchanger module 121, which has 30 multi-tubes 2190. After partially condensing in module 121, the refrigerant passes through tube 561 to heat exchanger module 122, which has 20 active multi-tubes 2190. After further condensing in module 122, the refrigerant passes through tube 562 to heat exchanger module 123, which has 15 active multi-tubes 2190. After further condensing in module 123, the refrigerant passes through tube 563 to heat exchanger module 124, which has 10 active multi-tubes 2190. In the example of air conditioning unit 102, each successive module (e.g., in series relative to the refrigerant) or pass has fewer active multi-tubes 2190 (e.g., connected in parallel) than the previous module or pass.

In other embodiments, however, some (or all, in some embodiments) successive modules or passes (e.g., in series relative to the refrigerant) may have the same number of multi-tubes 2190, for example, to obtain the desired dimensions of the heat exchanger assembly or air conditioning unit, or to reduce the number of different heat exchanger module sizes that are required (e.g., to be kept in inventory. For instance, in the example of unit 101, shown in FIG. 3, hot refrigerant gas or vapor leaves compressor 309 and travels through tubing 367 to heat exchanger module 122, which has 20 multi-tubes 2190. After partially condensing in module 122, the refrigerant passes through tube 361 to heat exchanger module 123, which has 15 active multi-tubes 2190. After further condensing in module 123, the refrigerant passes through tube 362 to heat exchanger module 124, which has 10 active multi-tubes 2190. And after further condensing in module 124, the refrigerant passes through tube 363 to heat exchanger module 125, which also has 10 active multi-tubes 2190. In some embodiments, heat exchanger module 125 may be identical to or interchangeable with heat exchanger module 124. Air conditioning unit 1103 shown in FIG. 11 is another example of a unit that has the same number of multi-tubes 2190 in the last two passes of the heat exchanger assembly (e.g., 1113). In this example, however, the last two passes are both within heat exchanger module 1026. Other embodiments may have other combinations of numbers of multi-tubes 2190 in successive modules or passes.

Various air conditioning units (e.g., 101, 102, and 1103) may have a name plate, which may be mounted on or attached to the heat exchanger assembly (e.g., 111, 112, or 1113). An example of such a name plate, name plate 1550, is shown in FIG. 15 on side 256 of heat exchanger assembly 111, and from behind, in FIG. 14. In some embodiments, such a name plate may include or display a brand name of the air conditioning unit (e.g., 101), and the name plate (e.g., 1550) may be attached to one or more of the spacers (e.g., 1235), for instance, with an adhesive or fasteners, or may be attached to the heat exchanger assembly (e.g., to one or two heat exchanger modules), which may be at a location where there is a gap in the spacer. FIG. 19 illustrates an example of such a gap, gap 1900 in spacer 1235. As shown in FIG. 14, the name plate (e.g., 1550) may include one or more projections (e.g., projections 1450) that may snap into gap 1900 and attach to heat exchanger modules 122 (above), 123 (below), or both, for example.

As shown in FIGS. 1 to 5, 11 to 16, and 21 to 25, in a number of embodiments, various modules are stacked on top of each other to form the heat exchanger assemblies. For example, in FIG. 2, module 124 is stacked on top of module 125, module 123 is stacked on top of module 124, and module 122 is stacked on top of module 123. Various modules (e.g., 121-125 and 1026) may be stacked on top of each other, for instance, with spacers (e.g., 1235) in between. As used herein, “stacked on top” means in the vertical direction (with our without spacers in-between, or other structure holding the modules together or within a controlled distance from each other) when in the orientation that the units are usually in when installed.

Different modules (e.g., 121-125 or 1026) in a heat exchanger assembly (e.g., 111, 112, or 1113) may be structurally attached or held together with various hardware or structural components, besides the spacers described herein, which, in a number of embodiments, include clips, rails, or both. Clip 1888 shown in FIGS. 3, 5, 11 to 16, 18, and 26 to 28 is an example of such a clip, and may be made of a flat piece of metal (e.g., sheet metal), for example. In other embodiments, clip 1888 may be made of plastic. Clip 1888 is a “center clip”, as that phrase is used herein, meaning that it attaches adjacent heat exchanger modules (e.g., a combination of some of modules 121 to 125 and 1026) to each other to form the heat exchanger assembly (e.g., 111, 112, or 1113), as opposed to attaching the heat exchanger assembly to the top housing section (e.g., 131 or 132), which would be called “top clips”, and as opposed to attaching the heat exchanger assembly to the bottom housing section (e.g., 141 or 142), which would be called “bottom clips”. In some embodiments, certain clips may have multiple functions, such as attaching two modules together, and serving as an attachment point for other components, such as panels, housing sections, or various structural members.

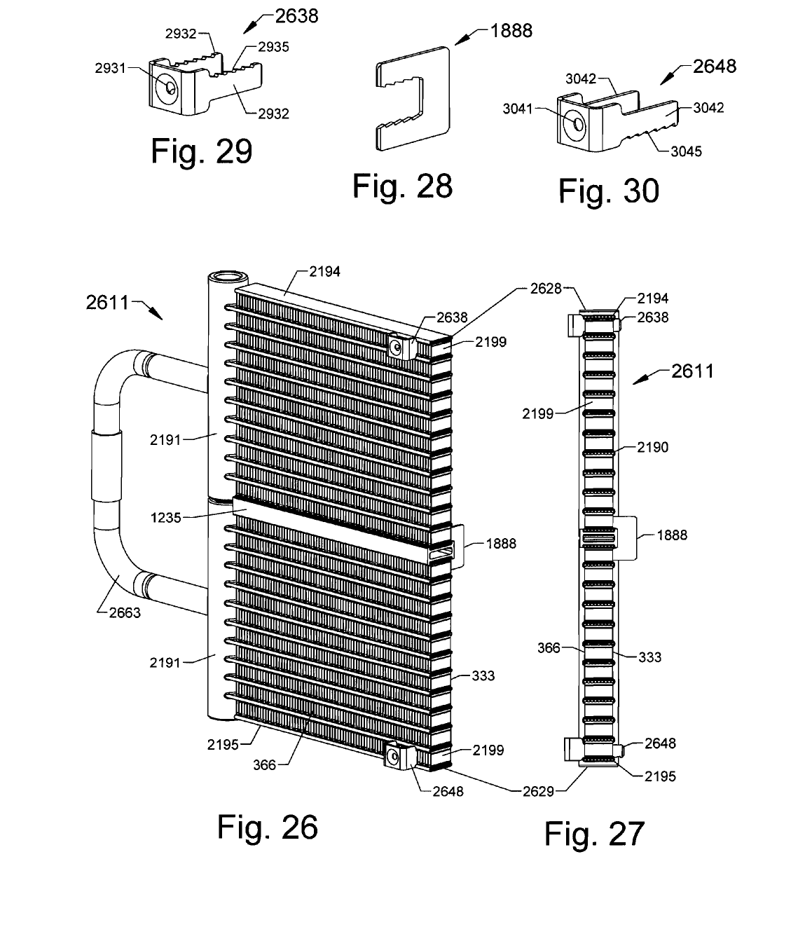

In the embodiment illustrated, multiple attachment clips 1888 are installed on the inside surface 333 (as opposed to the outside surface 366, both of which are labeled in FIGS. 3, 5 to 7, 12 to 16, 26, and 27) of the heat exchanger (e.g., 111, 112, or 1113), and act to sandwich spacer 1235 between adjacent heat exchanger modules (e.g., in an interference fit). In FIGS. 26 and 27, center clip 1888 attaches heat exchanger modules 2628 and 2629, on the inside surface 333, sandwiching spacer 1235 therebetween, to form heat exchanger assembly 2611. In other embodiments, a snap connection between the spacers and heat exchanger modules may be sufficient such that center clips (e.g., 1888) may be omitted.

FIGS. 26, 27, 29, and 30 also illustrate that in some embodiments, top clips, bottom clips, or both, may be used to attach the heat exchanger assembly to the top section, base, or both. In the embodiment illustrated, tabs 2932 of top clips 2638 fit into fins 2199 below the inactive top multi-tube 2194 with serrations 2935 pointed upward and hole 2931 on the outside surface 366 of module 2628 of heat exchanger assembly 2611. Tabs 2932 may have an interference fit with fins 2199, and tabs 2932 may deform fins 2199 when the tabs are inserted. Top clip 2638 may stay in place once inserted, unless forcefully removed. Also in the embodiment illustrated, tabs 3042 of top clips 2648 fit into fins 2199 above the inactive bottom multi-tube 2195 with serrations 3045 pointed downward and hole 3041 on the outside surface 366 of module 2629 of heat exchanger assembly 2611.

In some embodiments, top clips 2638 and bottom clips 2648 may be the same or interchangeable, except that one may be used upside down from the other (e.g., with reference to serrations 2935 and 3045). In other embodiments, top clips 2638 and bottom clips 2648 may be different, for example, and may have different size tabs (e.g., 2932 and 3042) if used with modules 2427 and 2428 shown in FIGS. 24 and 25, for example, or bottom clips 2648 may be made from heavier material (e.g., thicker sheet metal) that top clips 2638 to accommodate the added weight of heat exchanger assembly 2611. Top and bottom clips 2638 and 2648 may be made by stamping or bending sheet metal, or may be plastic, in different embodiments, as examples.

Referring to FIGS. 2 to 5, the top housing section (e.g., 131 or 132) may be attached to the heat exchanger assembly (e.g., 111 or 112) with screws 231 (e.g., hex head, Phillips head, slot head, Allen head, star or TORX head sheet metal screws), which may pass through holes in the top housing section 131 or 132 and thread into holes 2931 in top clips 2638. In some embodiments, screws 231 and top clips 2638 may be provided in other locations, in addition or instead of those shown in FIGS. 2 to 5. Similarly, the base section (e.g., 141 or 142) may be attached to the heat exchanger assembly (e.g., 111 or 112) with screws 241, which may pass through holes in the base section and thread into holes 3041 in bottom clips 2648. Screws 231 and 241 may be interchangeable, or may be different sizes, have different types of heads, or both, in different embodiments. Further, screws 241 and bottom clips 2648 may be provided in other locations, in addition or instead of those shown in FIGS. 2 to 5, for instance.

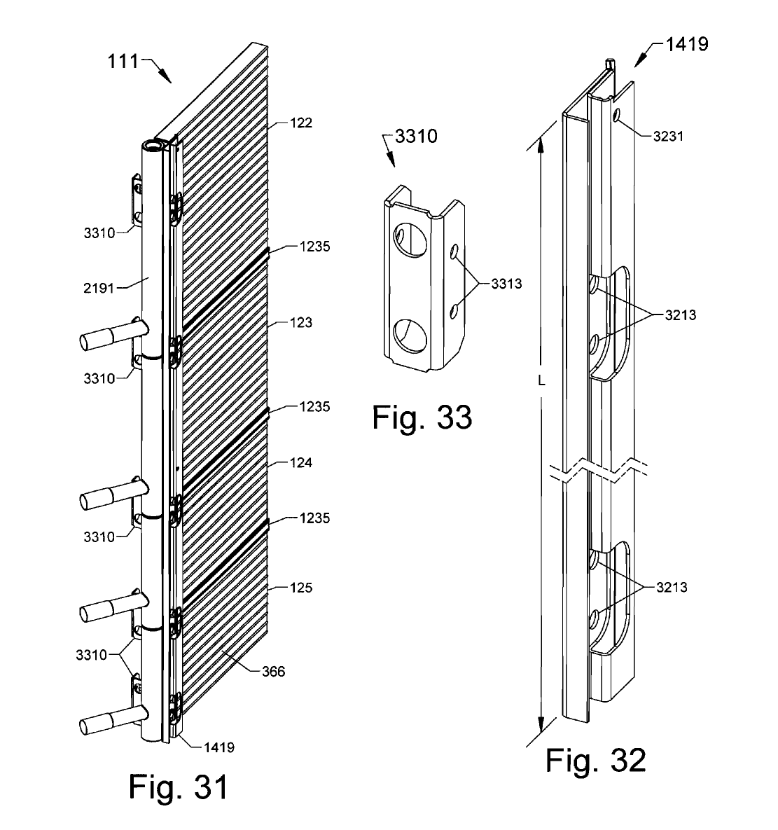

In a number of embodiments, in addition to or instead of clips, attachment rails may provide structural strength, stiffness, or both, to heat exchanger assemblies (e.g., 111, 112, or 1113). In the embodiment illustrated, FIGS. 13 to 15 show attachment rails 1418 and 1419, with the best view being in FIG. 14 where module 122 is omitted. These same attachment rails, or similar ones for other heat exchanger assemblies or units, are shown, but not marked, in FIGS. 3, 5, 11, 12, and 16. Attachment rail 1419 is also shown in FIG. 31, and in a partial closer view in FIG. 32.

As shown in FIG. 32, attachment rail 1419 has a long dimension L in the vertical direction. As used herein, a “long dimension” is or includes the longest overall dimension of an item and the longest overall dimension of an item that is measured in a direction that is parallel to at least one side of the item. In FIG. 32, dimension L is parallel to the vertical sides of rail 1419 (although a diagonal dimension from corner to corner would be slightly longer). In the embodiment illustrated, the long dimension L is substantially parallel (herein meaning parallel to within 10 degrees) to the width (w shown in FIGS. 6 to 8 for modules 122 to 124) of each of modules 122 to 125 of heat exchanger assembly 111 of unit 101, for example.

In the embodiment illustrated, attachment rails 1418 and 1419 are attached on the outside 366 of heat exchanger 111. In other embodiments, attachment rails may be attached on inside surface 333. In the embodiment illustrated, for each attachment rail, several rail clips 3310 are attached at the inside surface 333 of heat exchanger 111, each with two fasteners 1410 which pass through holes 3213 in the rail (e.g., rail 1419 shown in FIG. 32), through or between fins 2199 in heat exchanger assembly 111, and into holes 3313 (either directly or into a speed clip positioned thereover) shown in FIG. 33, as an example. Fasteners 1410 may be sheet metal screws, pop rivets, or bolts, as examples.

In the embodiment shown, one rail clip 3310 is provided near one end (e.g., the top) of the heat exchanger assembly (e.g., 111) and near one end (e.g., the top) of the attachment rail (e.g., 1419) through the heat exchanger module at that end (e.g., module 122 shown in FIGS. 13, 15, and 31). Also in this embodiment, one rail clip 3310 is provided near the other end (e.g., the bottom) of the heat exchanger assembly (e.g., 111) and near the other end (e.g., the bottom) of the attachment rail (e.g., 1419) through the heat exchanger module at that end (e.g., module 125 shown in FIGS. 13, 14, and 31). Further, in the embodiment illustrated, one rail clip 3310 is provided straddling (e.g., with one fastener 1410 on each side) each joint between two heat exchanger modules (e.g., between module 122 and 123, between module 123 and 124, and between modules 124 and 125), and also straddling the spacers 1235. These rail clips 3310 are located between the two ends (e.g., the top and the bottom) of the heat exchanger assembly (e.g., 111) and the attachment rail (e.g., 1419).

Thus, in this embodiment, each attachment rail 1418 and 1419 in heat exchanger 111 of air conditioning unit 101 has five rail clips 3310. Other embodiments may have a different number of rail clips, such as 3, 4, 6, 7, 8, 9, or 10, as examples, or may have an inner attachment rail (e.g., on inside surface 333) instead of multiple rail clips 3310, as another example. In the embodiment shown, attachment rails 1418 and 1419, and rail clips 3310 may be sheet metal, or may be plastic, as examples. As used herein, where sheet metal is mentioned, it may be steel, may be galvanized, may be coated, or a combination thereof, or may be aluminum, as examples. In some embodiments, rails may have the shape illustrated that combines a channel and an angle formed by bending the same piece of material. In other embodiments, the rails may have another shape, such as a C channel, two or more nested channels, an angle, a T-section, a twin T-section, a round, oval, square, triangular, trapezoidal, trapezial, or rectangular tube, or a combination thereof, or the like.

In the embodiment depicted, for instance, in FIGS. 13 to 15, an attachment rail 1418 is attached to each heat exchanger module 122 to 125 at the end of the modules at side 258, and an attachment rail 1419 is attached to each heat exchanger module 122 to 125 at the other end of the modules at side 259. In some embodiments, attachment rails 1418 and 1419 may be the same or interchangeable, while in other embodiments they may be opposite hand, or may be different in other ways. Other embodiments may have one attachment rail at either end or at a central location, or may have more than two attachment rails (e.g., like rails 1418 and 1419). Various embodiments may have 1, 2, 3, 4, 5, 6, 7, 8, 9, 10, or more attachment rails, for example, which may be spaced at regular intervals, for instance. Further, in some embodiments, rear panel 205 may attach to attachment rails 1418 and 1419, to rail clips 3310, or both, for example, with fasteners, such a sheet metal screws (e.g., screws 204 shown in FIG. 2). Moreover, in some embodiments, the top section (e.g., 131), base (e.g., 141), or both may attach to attachment rails 1418 and 1419, to rail clips 3310, or both, for example, with fasteners, such a sheet metal screws (e.g., with screws 202 shown in FIG. 2, or into holes 3231 shown in FIG. 32, either directly or into a speed clip positioned thereover).

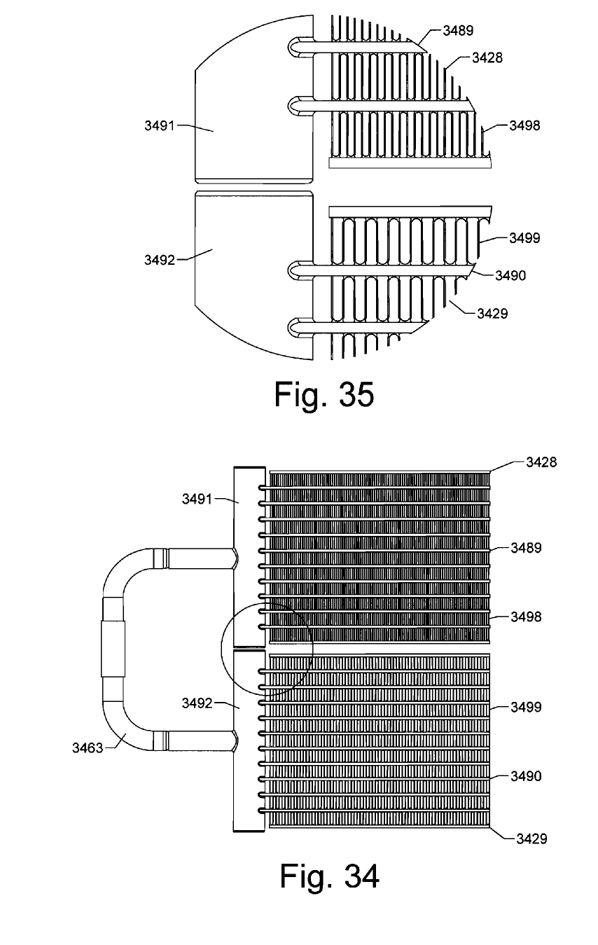

In some embodiments, various parameters of the heat exchanger modules may differ between different modules. It has been discussed that width (w shown in FIGS. 6 to 10) and thickness (shown in FIGS. 24 and 25) may vary between different modules. In other embodiments, other parameters may vary, such a fin type, fin thickness, number or size of refrigerant passageways in the multi-tubes, distance between multi-tubes, header sizes, connecting refrigerant conduit or tubing sizes, angle or slope of the rows of the refrigerant passageways in the multi-tubes, number of rows of refrigerant passageways in the multi-tubes, thickness of the fins, etc. FIGS. 34 and 35 show that in some embodiments, different modules may have a different fin spacing.

In the embodiment illustrated in FIGS. 34 and 35, heat exchanger modules 3428 and 3429 are connected in series through connecting refrigerant conduit or tubing 3463. In this embodiment, heat exchanger module 3428 has multi-tubes 3489 and fins 3498, and heat exchanger module 3429 has multi-tubes 3490 and fins 3499. Multi-tubes 3489 and 3490 may be similar or identical, in this embodiment, but fins 3498 and 3499 have a different spacing, with the fins 3498 being spaced more closely. The closer space fins of module 3428 may transfer more heat for a given airflow rate through the module, but may restrict airflow more, resulting in less airflow through module 3428 and a corresponding reduction in heat transfer.

In some embodiments, the fin spacing (or other parameters of the heat exchanger modules) may be varied to control the air speed velocity or airflow rate through the heat exchanger assembly, for example, to provide a more even or uniform airflow rate through the different modules. This may be done, for instance, to compensate for differences in airflow rates that otherwise would occur in different locations in the air conditioning due to differing proximity to the fan (e.g., fan 303 or 503), proximity to compressor 309 or 509, or the like. In some embodiments, fewer fins per unit of length (e.g., as illustrated by fins 3499 of module 3429) may be provided in areas where normal airflow through the heat exchanger assembly is restricted by nearby objects within the heat exchanger assembly or in areas where it would be desirable to have higher velocity air over the fins or multi-tubes, or in areas where it would otherwise be difficult to draw the desired amount of air with the particular fan location.

As another example, in some embodiments, components may be provided or configured to block airflow, or portions of heat exchangers (or heat exchanger modules) may be omitted, where airflow would be reduced or substandard, or components may be spaced further apart to provide a more uniform airflow rate through the heat exchanger assembly or modules. For example, in some embodiments, airflow rate though the heat exchanger or heat exchanger module may be substantially lower above the fan (e.g., fan 303 or 503 in FIGS. 3 and 5). In some embodiments, spacer 1231 (above the heat exchanger assembly) is wider (e.g., in the direction of w shown in FIGS. 6 to 9) or taller, than what is shown in the drawings so that airflow rate through the top of the heat exchanger assembly (e.g., 111, 110, or 1113) or module (e.g., 122 or 122) is higher or more uniform with the other parts of the heat exchanger assembly.

In some embodiments, for instance, spacer 1231 may be 2, 3, or 4 inches wide (or tall), or more, for example. Such a wider or taller spacer 1231 may be constructed similarly to the spacers described herein (e.g., except with a larger dimension in the vertical direction) or may be made by bending sheet metal, as another example. In embodiments where plastics are used (e.g., for various spacers described herein, such as spacers 1231, 1235, and 1241) plastics or coatings (or both) with suitable resistance to ultraviolet degradation may be selected. Use of a wider or taller spacer (e.g., 1231) may result in the air conditioning unit being taller, may reduce the width or height of heat exchanger assembly that is required, or both. In other embodiments, the top section (e.g., 131 or 132) may fulfill this role (e.g., be taller) instead of having a wider or taller spacer 1231.

Further, in some embodiments, a shroud may be provided around the fan (e.g., 303 or 503), for example, inside surface 333, for instance, to provide a more uniform airflow rate at the top of the heat exchanger assembly or the top-most heat exchanger module (e.g., module 121 or 122 in the embodiments illustrated). Further, in other embodiments, other spacers, such as spacer 1241 below the heat exchanger, may be wider or taller than what is shown, for instance, which may provide a more uniform airflow rate, make the unit taller, or both.

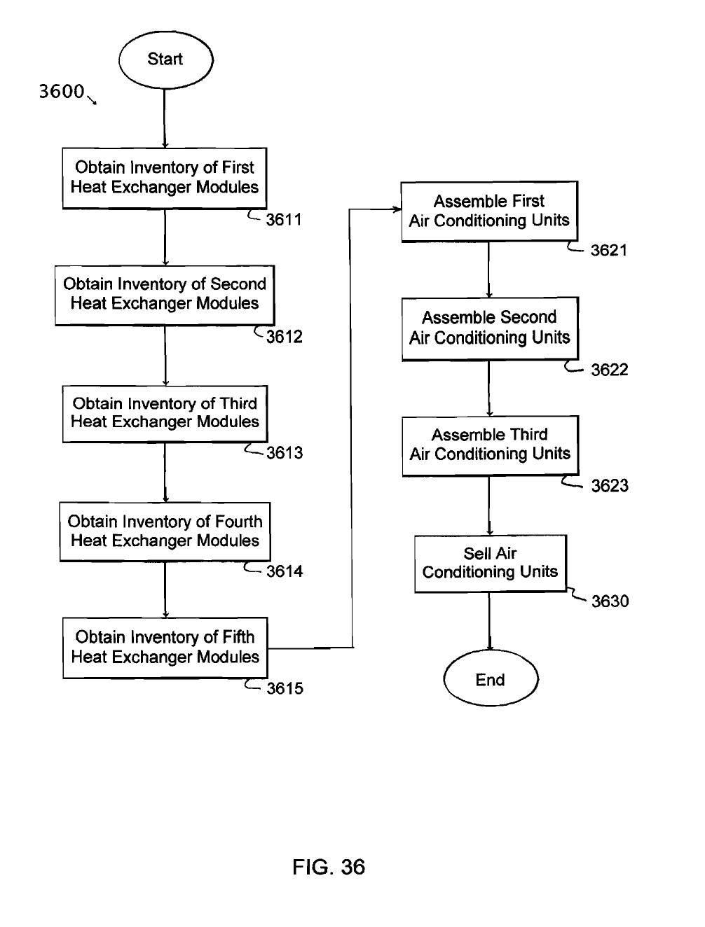

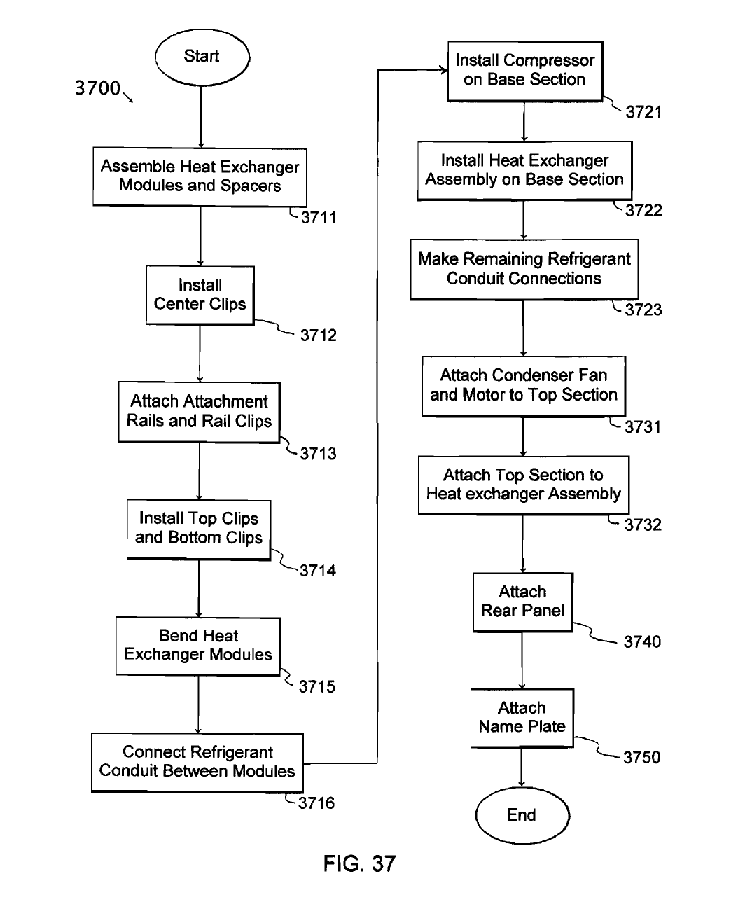

FIG. 36 illustrates an example of a method of manufacturing different capacity air conditioning units (e.g., in inventory 100) using certain heat exchanger modules (e.g., 121 to 125 or 1026). FIG. 37 takes a closer look at such a method, focusing, as another example, on the manufacturing of one particular air conditioning unit (e.g., one of the units 101, 102, or 1103). Various embodiments of the invention may include combinations of acts illustrated in FIGS. 36 and 37, described herein, known in the art, or a combination thereof. FIGS. 36 and 37 illustrate one suggested order for performing the acts identified, but other sequences may be possible, or even advantageous, in particular circumstances.

Method 3600, shown in FIG. 36, illustrates, among other things, a method of providing, manufacturing, or distributing different air conditioning units using selections of particular heat exchanger modules. Method 3600 includes acts 3611, 3612, 3613, 3614, and 3615 of obtaining inventories of first through fifth, for a total of five, (e.g., different or significantly different) heat exchanger modules. Such modules may be manufactured or purchased from a supplier, for example, and may be stored, for instance, at a location reasonably near to where the manufacturing or assembling of the air conditioning units takes place. These five modules may be, for example, modules 121 to 125, or 121 to 124 and 1026, as examples. Although method 3600 includes obtaining inventories of five (first through fifth) heat exchanger modules, other embodiments may obtain inventories of 3, 4, 6, 7, 8, 9, 10, or more (e.g., different) heat exchanger modules.

Heat exchanger modules (e.g., 121 to 125 and 1026 shown in FIGS. 1-16), such as micro-channel heat exchanger modules, may be formed (e.g., using aluminum) by extruding the multi-tubes (e.g., 2190, 2194, 2195, 2394, and 2395 shown in FIGS. 21-23) and cutting to length, cutting and bending the fins (e.g., 2199), cutting the headers (e.g., 2191, 1092, 1093, 2491, 2492, 3491, and 3492 shown in FIGS. 3, 5 to 16, 21, 24, 26, 31, and 34), and soldering these components together in an oven, for example.

The first heat exchangers that are obtained (e.g., in act 3611) may all be the same as each other, for example, in dimensions, properties, etc. or may be interchangeable with each other. Similarly, the second heat exchangers that are obtained (e.g., in act 3612) may all be the same, or may be interchangeable with each other. In many embodiments, the same may be true for the third heat exchanger modules (e.g., obtained in act 3613), the fourth heat exchanger modules (e.g., obtained in act 3614), and the fifth heat exchanger modules (e.g., obtained in act 3615).

However, in a number of embodiments, the first heat exchangers that are obtained (e.g., in act 3611) may all be different from (e.g., in dimensions, properties, etc.) the second heat exchangers that are obtained (e.g., in act 3612). Similarly, the second heat exchangers that are obtained (e.g., in act 3612) may all be different than the third heat exchanger modules (e.g., obtained in act 3613). In many embodiments, the same may be true for the third heat exchanger modules (e.g., obtained in act 3613), the fourth heat exchanger modules (e.g., obtained in act 3614), and the fifth heat exchanger modules (e.g., obtained in act 3615). In a number of embodiments, each inventory (e.g., obtained in acts 3611 to 3615) may have different (e.g., size, number of multi-tubes, thickness, fin spacing, etc., or a combination thereof) modules.

Method 3600 also includes acts 3621, 3622, and 3623 of assembling first, second, and third air conditioning units (e.g., units 101, 102, and 1103). In a number of embodiments, these first, second, and third air conditioning units may include (or all be) different sizes or capacities (e.g., tonnage), and may have different combinations of the first to fifth heat exchanger modules (e.g., obtained in acts 3611 to 3615). Although method 36 shows assembling first, second, and third (e.g., three different) air conditioning units, other embodiments may assemble 2, 4, 5, 6, 7, 8, 9, 10, or more (e.g., different) air conditioning units. In the embodiment illustrated, method 3600 (e.g., in embodiments wherein air conditioning units are distributed to others) also includes the act 3630 of selling the air conditioning units. Air conditioning units (e.g., assembled in acts 3621 to 3623) may be sold (e.g., in act 3630) to or through distributors, wholesalers, retailers, installers, dealers, contractors, building owners (e.g., building 280 of FIG. 2), or end users, and may be advertised or sold through conventional channels, or through the Internet, as examples.

The first air conditioning units that are assembled (e.g., in act 3621) may all be the same as each other, for example, in dimensions, properties, capacity, etc. or may be interchangeable with each other. Similarly, the second air conditioning units that are assembled (e.g., in act 3622) may all be the same, or may be interchangeable with each other. In many embodiments, the same may be true for the third air conditioning unit modules (e.g., assembled in act 3623).

Although shown as discrete acts, in many embodiments, the acts of obtaining inventories of heat exchanger modules (e.g., acts 3611 to 3615) and assembling air conditioning units (e.g., acts 3621 to 3623) may be performed continuously (e.g., during certain business hours), or may be repeated. Inventories of heat exchanger modules may be maintained and resupplied periodically, and air conditioning units (e.g., units 101, 102, and 1103) may be assembled in a production line process using the heat exchanger modules (e.g., 121 to 125 and 1026 shown in FIGS. 1-16).

Method 3700, illustrated in FIG. 37, shows, for instance, details concerning an example of how the first, second, or third (or a combination thereof) air conditioners may be assembled (e.g., in one or more of acts 3621 to 3623 of method 3600). Method 3700 includes act 3711 of assembling the heat exchanger modules and spacers. For example, in the case of air conditioning unit 101, heat exchanger modules 122, 123, 124, and 125 are stacked together, in the embodiment illustrated, along with spacers 1235, and, in a number of embodiments, also spacers 1231, 1241, or both. The modules and spacers may be lined up and snapped together at this point, or in some embodiments, an adhesive may be applied between them, as examples. In some embodiments, the modules and spacers are straight at this point, lacking bends 251, 252, and 253, for instance.

In the example of method 3700, center clips 1888 may then be installed (act 3712), for example, on inside surface 333 of the heat exchanger assembly, sandwiching the spacer (e.g., 2335 shown in FIG. 23) between the inactive multi-tubes (e.g., 2394 and 2395) of adjacent heat exchanger modules. On the other hand, in other embodiments, the snap connection (or interference fit, adhesive, or a combination thereof) between the modules and spacers may be adequate, or other attaching structure may be used, and the act of installing center clips (e.g., 1888) may be omitted.

In some embodiments, the attachment rails (e.g., 1418 and 1419 shown in FIGS. 14 and 32) and rail clips (e.g., 3310 shown in FIGS. 14, 15, and 33) may then be installed (act 3713). In the embodiment illustrated, top clips (e.g., 2638 shown in FIGS. 26 and 30) and bottom clips (e.g., 2648 shown in FIGS. 26 and 29) may then be installed (act 3714), for instance, in the top and bottom rows of fins (e.g., 2199) in the top and bottom heat exchanger modules (e.g., 122 and 125 of heat exchanger assembly 111).

In other embodiments, the attachment rails and rail clips may be installed (act 3713) before the center clips are installed (act 3712), or concurrently, or the top and bottom (attachment) clips may be installed (act 3714) before, between, or concurrently with such acts (i.e., 3712 and 3713) or at a later time (e.g., before the heat exchanger assembly is attached to the base section and top section (e.g., before acts 3722 and 3725). To install the attachment rails (e.g., 1418 and 1419) and rail clips (e.g., 3310), in some embodiments wherein fasteners 1410 are sheet metal screws, for example, fasteners 1410 may be driven through holes 3213 and fins 2199 from outside surface 366 to appropriately sized holes 3313 or speed clips in rail clips 3310.

In the embodiment illustrated, the heat exchanger modules or assembly is then bent (act 3715), for instance, forming substantially right-angle bends 251, 252, and 253 (shown for example, in FIGS. 2, 3, and 6 to 10). In a number of embodiments, all of the heat exchanger modules (e.g., 122 to 125 in module 111 for air conditioning unit 101), the interior spacers (e.g., 1235), and in some embodiments, also the top spacers 1231 and bottom spacers 1241 are bent together (i.e., the heat exchanger assembly is bent as a unit). In some embodiments, the heat exchanger assembly is bent (act 3715) before some or all of the clips or rails are installed (acts 3712 to 3714) or before the top and bottom spacers (e.g., 1231 and 1241) are installed, as another example.

The next act shown in method 3700 is act 3716 of connecting the refrigerant conduit between the modules. For example, the refrigerant conduit or tubing 361, 362, and 363 may be installed, as shown in FIGS. 3 and 13 for heat exchanger module 111 for air conditioning unit 101. In some embodiments, the refrigerant conduit between the modules may be copper tubing, for example, and may be attached to the aluminum heat exchanger modules, for example, by resistance welding or via a mechanical connection, such as using a compression ring, or as described herein, for instance.

In some embodiments, such as illustrated by FIGS. 21, 24, 26, and 34, for instance, having refrigerant conduit or tubing 2163, 2463, or 2663, that connect the modules on the same end of the modules or same side of the heat exchanger assembly, it may be an option to install and connect (at least those sections of) the refrigerant conduit (act 3716) before the heat exchanger modules or assembly is bent (act 3715). On the other hand, in some embodiments, some or all connections of the refrigerant conduit between modules may be made later (e.g., in act 3723 when other refrigerant conduit or tubing connections are made).

Still referring to FIG. 37, in the embodiment illustrated, method 3700 also includes an act of installing the compressor on the base section (act 3721). For example, referring to FIG. 3, compressor 309 may be installed on base 141, or referring to FIG. 5, compressor 509 may be installed on base 142. The compressors may be installed, for instance, with fasteners, such as screws or bolts, as examples. In different embodiments, act 3721 of installing the compressor on the base section may be performed before, during, or after acts 3711 to 3716 of assembling the heat exchanger assembly.

Method 3700 next illustrates installing the heat exchanger assembly on the base section (act 3722). For example, referring to FIGS. 2, 3, and 26, heat exchanger assembly 111 may be attached to base section 141 with fasteners, such as screws 241 and 202, which may be screwed through holes in base section 141 into bottom clips 2638 (shown in FIG. 29), rails 1418 and 1419, or a combination thereof, as examples. Acts 3721 of installing the compressor and 3722 of installing the heat exchanger assembly, may be performed in either order, in different embodiments.

In a number of embodiments, the heat exchanger assembly (e.g., 111, 112, or 1113) may be handled (e.g., moved or stored) or installed, as a unit. As used herein, “installing as a unit”, when referring to a heat exchanger assembly that forms part of an air conditioning unit, for example, means assembling the heat exchanger assembly, handling the assembly as a unit, and then combining the assembly with other parts to form the air conditioning unit (e.g., acts 3722, 3732, and 3740). As used herein, the “heat exchanger assembly” means (at least) the heat exchanger modules (e.g., 122 to 125 for heat exchanger assembly 111), and, where provided, the spacers that go between the modules (e.g., 1235, 2335, 2535, or a combination thereof, and sufficient structure to hold them together for handling purposes. In some embodiments, this structure may include, for example, center clips 1888 (e.g., FIGS. 18 and 26), rails 1418 and 1419 and rail clips 3310 (e.g., FIGS. 14, 32, and 33), or a combination thereof. Further, in some embodiments, the heat exchanger assembly further includes other items, for instance, connecting refrigerant conduit or tubing (e.g., 361 to 363 shown in FIG. 13), top and bottom spacers (e.g., 1231 and 1241 shown in FIG. 14), and top and bottom clips (e.g., 2638 and 2648 shown in FIGS. 26, 29, and 30).

Method 3700 of FIG. 37 further includes, in the embodiment illustrated, an act of making remaining refrigerant conduit connections (act 3723). This may include, for example, installing and connecting conduit or tubing 367 from heat exchanger assembly 111 to compressor 309, and installing and connecting the portions of vapor and liquid refrigerant lines 260 and 270 shown, for example, in FIGS. 2 and 3. These conduit or tubing connections may be as described above for act 3716, and in some embodiments, may include making the connections of act 3716, namely, connecting refrigerant conduit (e.g., 361 to 363 shown in FIG. 13) between the modules.

In the embodiment shown, method 3700 also includes act 3731 of attaching the condenser fan and motor to the top section. For example, fan 303 (shown in FIG. 3 for unit 101) may be attached to the shaft of motor 220 (shown in FIGS. 2 and 3), which may be attached to grill 210 (e.g., with fasteners such as screws, bolts, nuts, or a combination thereof). Grill 210 may be attached to top section 131, with fasteners such as sheet metal screws, bolts, or rivets. In different embodiments, these components may be assembled in a different order.

Method 3700 also includes an act of attaching the top section to the heat exchanger assembly (act 3732). For instance, in the case of air conditioning unit 101, top section 131, with grill 210, motor 220, and fan 303 already attached, may be placed on heat exchanger assembly 111 and attached with fasteners, such as sheet metal screws 231, to top clips 2638 (shown in FIGS. 26 and 29), rails 1418 and 1419 (shown in FIGS. 14 and 32), other structural members, or a combination thereof, as examples. Fan 303, in this embodiment, is positioned within air conditioning unit 101 to move air through heat exchanger 111 when fan 303 is turned or driven by motor 220.

Further, method 3700, in the embodiment illustrated, also includes an act 3740 of attaching the rear panel. For example, rear panel 205 (shown in FIG. 2, for example) may be attached (act 3740) with fasteners such as screws 202, 204, other fasteners, tabs that fit into slots, or a combination thereof. In other embodiments, the rear panel may be installed or attached (act 3740) before the top section is installed or attached to the heat exchanger assembly (act 3732), or concurrently.

In a number of embodiments, essentially the same air conditioning units (e.g., 101 and 102) are sold under different brand names, for example, through different distributors, retailers, or sales representatives, to different target customers, or the like. In such embodiments, it is advantageous to be able to manufacture or assemble units first (e.g., acts 3711 to 3740 of method 3700) and assign to them a brand name later, for example, when units have been ordered to be sold under that name. Accordingly, in the embodiment illustrated, method 3700 includes an act 3750 of installing the name plate (e.g., 1550 shown in FIGS. 14 and 15) for the unit as a final act in the process (e.g., method 3700) of manufacturing or assembling the air conditioning unit. In different embodiments, the name plate (e.g., 1550) may be attached (e.g., in act 3750) to the spacer (e.g., 1235) or at a location where there is a gap (e.g., gap 1900 shown in FIG. 19) in the spacer (e.g., 1235). Other embodiments, however, may include installing the name plate earlier, for instance, after the heat exchanger assembly is assembled (e.g., after one of acts 3711 to 3716) or attaching the name plate at a different location on the unit.

In the embodiment illustrated, acts 3711 to 3716 describe the manufacture or assembly of the heat exchanger assembly (e.g., 111. 112, or 1113). Acts 3721 to 3723 describe the installation of components and assemblies on the base section (e.g., 141 or 142), acts 3731 and 3732 describe assembly and installation of the top section, and acts 3740 and 3750 describe installation of the back panel and name plate. It should be understood that other steps or acts may be required for the manufacture or assembly of air conditioning units, which would be within the abilities of a skilled artisan. Method 3700 may be repeated for different air conditioning units of the same or different capacities, and manufacturing or assembly may be performed using an assembly line where the various acts are performed repeatedly for different units.

As described, different size or capacity air conditioning units (e.g., 101 and 102) may be manufactured or assembled (e.g., acts 3621 to 3623 shown in FIG. 36) using inventories of heat exchanger modules (e.g., 121 to 125) that have been obtained (e.g., in acts 3611 to 3615), where the inventories include different sizes of modules that have at least one dimension that is significantly different than a corresponding dimension of other size modules, and multiple substantially identical modules are provided of each size or type. In various embodiments, different combinations of the different size modules are used to manufacture or assemble different size or capacity air conditioning units (e.g., condensing units). Methods of manufacturing or providing such air conditioning units may include obtaining or providing various combinations of the features described herein. Other embodiments may be apparent to a person of ordinary skill in the art having studied this document, and may include features or limitations described herein, shown in the drawings, or both.

1. A method of manufacturing different capacity air conditioning units using common heat exchanger modules, the method comprising in any order, except where order is explicitly indicated, at least the acts of:
obtaining an inventory of substantially identical first heat exchanger modules;
obtaining an inventory of substantially identical second heat exchanger modules, wherein the second heat exchanger modules have at least one dimension that is significantly different than a corresponding dimension on the first heat exchanger module;
obtaining an inventory of substantially identical third heat exchanger modules, wherein the third heat exchanger modules have at least one dimension that is significantly different than a corresponding dimension on the first heat exchanger module, and wherein the third heat exchanger modules have at least one dimension that is significantly different than a corresponding dimension on the second heat exchanger module;
assembling multiple first capacity substantially identical first air conditioning units using, for each first air conditioning unit, at least one first heat exchanger module, at least one second heat exchanger module, and no third heat exchanger module, wherein the assembling of each first air conditioning unit includes assembling the at least one first heat exchanger module and the at least one second heat exchanger module to form a first heat exchanger assembly, and then installing the first heat exchanger assembly as a unit, wherein the assembling of each first air conditioning unit includes connecting refrigerant conduit between the first heat exchanger module and the second heat exchanger module, and wherein the assembling of each first air conditioning unit further includes installing a first fan and a first electric motor, wherein the first electric motor drives the first fan and the first fan is positioned within the first air conditioning unit to move air through the first heat exchanger assembly; and
assembling multiple second capacity substantially identical second air conditioning units using, for each second air conditioning unit, at least one second heat exchanger module and at least one third heat exchanger module, wherein the assembling of each second air conditioning unit includes assembling at least the at least one second heat exchanger module and the at least one third heat exchanger module to form a second heat exchanger assembly, and then installing the second heat exchanger assembly as a unit, wherein the assembling of each second air conditioning unit includes connecting refrigerant conduit between the second heat exchanger module and the third heat exchanger module, and wherein the assembling of each second air conditioning unit further includes installing a second fan and a second electric motor, wherein the second electric motor drives the second fan and the second fan is positioned within the second air conditioning unit to move air through the second heat exchanger assembly, wherein the second capacity of the second air conditioning units is significantly different than the first capacity of the first air conditioning units.

2. The method of claim 1 wherein the connecting of refrigerant conduit between the first heat exchanger module and the second heat exchanger module in the first heat exchanger assembly includes connecting the first heat exchanger module and the second heat exchanger module in series with respect to refrigerant that passes through the first heat exchanger assembly, each of the first heat exchanger module and the second heat exchanger module forming at least one complete pass of the first heat exchanger assembly; and wherein the connecting of refrigerant conduit between the second heat exchanger module and the third heat exchanger module in the second heat exchanger assembly includes connecting the second heat exchanger module and the third heat exchanger module in series with respect to refrigerant that passes through the second heat exchanger assembly, each of the second heat exchanger module and the third heat exchanger module forming at least one complete pass of the second heat exchanger assembly.

3. The method of claim 1 wherein the connecting of refrigerant conduit between the first heat exchanger module and the second heat exchanger module in the first heat exchanger assembly includes connecting the first heat exchanger module and the second heat exchanger module in parallel with respect to refrigerant that passes through the first heat exchanger assembly, each of the first heat exchanger module and the second heat exchanger module forming multiple passes of the first heat exchanger assembly; and wherein the connecting of refrigerant conduit between the second heat exchanger module and the third heat exchanger module in the second heat exchanger assembly includes connecting the second heat exchanger module and the third heat exchanger module in parallel with respect to refrigerant that passes through the second heat exchanger assembly, each of the second heat exchanger module and the third heat exchanger module forming multiple passes of the second heat exchanger assembly.

4. The method of claim 1 wherein the acts of obtaining the inventories of the first, second, and third heat exchanger modules include obtaining heat exchanger modules that each have a different number of fins per unit of length.

5. The method of claim 1 wherein the acts of obtaining the inventories of the first, second, and third heat exchanger modules include obtaining heat exchanger modules that each include multiple parallel multi-tubes, each multi-tube having multiple contiguous parallel refrigerant passageways arranged in at least one row, wherein each multi-tube is substantially parallel to a direction of refrigerant flow within the multi-tube, wherein each row is substantially parallel to a direction of air flow at the row, and wherein each heat exchanger includes multiple fins between the multi-tubes wherein the fins are bonded to the multi-tubes.

6. The method of claim 5 wherein the acts of obtaining the inventories of the first, second, and third heat exchanger modules include obtaining heat exchanger modules that each include a refrigerant header at each end of each heat exchanger module, wherein each header is connected to each multi-tube of the module for the passage of the refrigerant through the multi-tube, except for a top and a bottom multi-tube of each module, wherein the top and bottom multi-tube of each module are not connected to the headers for passage of the refrigerant.

7. The method of claim 1 wherein the acts of obtaining the inventories of the first, second, and third heat exchanger modules include obtaining second heat exchanger modules having an overall width dimension that is significantly different than a corresponding overall width dimension of the first heat exchanger modules; obtaining third heat exchanger modules having an overall width dimension that is significantly different than the corresponding overall width dimension of the second heat exchanger modules; and obtaining third heat exchanger modules having an overall width dimension that is significantly different than the corresponding overall width dimension of the first heat exchanger modules; and wherein the act of assembling the first heat exchanger assembly includes arranging the at least one first heat exchanger module and the at least one second heat exchanger module in parallel with respect to air that passes through the first heat exchanger assembly; and wherein the act of assembling the second heat exchanger assembly includes arranging the at least one second heat exchanger module and the at least one third heat exchanger module in parallel with respect to air that passes through the second heat exchanger assembly.

8. The method of claim 1 further comprising, after the act of assembling the at least one first heat exchanger module and the at least one second heat exchanger module to form the first heat exchanger assembly, and before the act of installing the first heat exchanger assembly as a unit, an additional act of bending the first heat exchanger assembly as a unit.

9. The method of claim 1 wherein the assembling of each first heat exchanger assembly includes placing a spacer between the first heat exchanger module and the second heat exchanger module to form the first heat exchanger assembly, and then installing the first heat exchanger assembly as a unit; and wherein the assembling of each second heat exchanger assembly includes placing a spacer between the second heat exchanger module and the third heat exchanger module to form the second heat exchanger assembly, and then installing the second heat exchanger assembly as a unit.

10. The method of claim 9 further comprising, after the acts of installing the first heat exchanger and assembling the first air conditioning unit as recited in claims 1 and 11 are completed, an act of attaching a name plate to each of the first air conditioning units, the name plate including a brand name of the first air conditioning unit, wherein the act of attaching includes at least one of:
attaching the name plate to the spacer; or
attaching the name plate to the heat exchanger assembly at a location where there is a gap in the spacer.

11. The method of claim 9 wherein the assembling of each first heat exchanger assembly includes attaching the first heat exchanger module and the second heat exchanger module to at least a first attachment rail, wherein the first attachment rail has a long dimension that is substantially parallel to the width of the first heat exchanger module and substantially parallel to the width of the second heat exchanger module, then bending the first heat exchanger assembly as a unit, and then installing the first heat exchanger assembly as a unit; and wherein the assembling of each second heat exchanger assembly includes attaching the second heat exchanger module and the third heat exchanger module to at least a second attachment rail, wherein the second attachment rail has a long dimension that is substantially parallel to the width of the second heat exchanger module and substantially parallel to the width of the third heat exchanger module, then bending the second heat exchanger assembly as a unit, and then installing the second heat exchanger assembly as a unit.

12. The method of claim 1 wherein the assembling of each first heat exchanger assembly includes attaching the first heat exchanger module and the second heat exchanger module to a first attachment rail at a first end of the first and second heat exchanger modules, and attaching the first heat exchanger module and the second heat exchanger module to a second attachment rail at a second end of the first and second heat exchanger modules, wherein each of the first and second attachment rails has a long dimension that is substantially parallel to the width of the first heat exchanger module and substantially parallel to the width of the second heat exchanger module, and after the first and second heat exchanger modules are attached to the first and second attachment rails, installing the first heat exchanger assembly as a unit.

13. A first air conditioning unit comprising:
a first heat exchanger assembly comprising at least a first heat exchanger module and a second heat exchanger module, wherein the first heat exchanger module is stacked on top of the second heat exchanger module, and wherein the first heat exchanger module and the second heat exchanger module are arranged in parallel with respect to air that passes through the first heat exchanger assembly, and wherein the first heat exchanger assembly includes connecting refrigerant conduit between the first heat exchanger module and the second heat exchanger module such that the first heat exchanger module and the second heat exchanger module are arranged in series with respect to refrigerant that passes through the first heat exchanger assembly, each of the first heat exchanger module and the second heat exchanger module forming at least one pass of the first heat exchanger assembly, and wherein each of the first and second heat exchanger modules include multiple parallel multi-tubes, the multi-tubes in each heat exchanger module being parallel to each other geometrically and arranged in parallel with respect to the flow of the refrigerant, each multi-tube having multiple contiguous parallel refrigerant passageways arranged in at least one row, and wherein each heat exchanger module includes multiple fins between the multi-tubes, wherein the fins are bonded to the multi-tubes;
a first fan positioned and configured to move air through the first heat exchanger assembly;
a first electric motor for driving the first fan; and
a first compressor configured to compress refrigerant.

14. The first air conditioning unit of claim 13 further comprising a spacer between the first heat exchanger module and the second heat exchanger module, wherein the spacer is configured to significantly reduce the amount of air that passes between the first heat exchanger module and the second heat exchanger module.

15. The first air conditioning unit of claim 14 further comprising a name plate attached to the air conditioning unit, the name plate including a brand name of the air conditioning unit, wherein the name plate is attached to at least one of:
the spacer; or
the heat exchanger assembly at a location where there is a gap in the spacer.

16. The first air conditioning unit of claim 13 wherein each heat exchanger module includes a refrigerant header at each end of the heat exchanger module, wherein each header is connected to each multi-tube of the module for the passage of the refrigerant through the multi-tube, except for a top and a bottom multi-tube of each module, and wherein the top and bottom multi-tubes are not connected to the headers for passage of the refrigerant.

17. The first air conditioning unit of claim 13, wherein the first heat exchanger module and the second heat exchanger module each consist essentially of aluminum, and the connecting refrigerant conduit between the first heat exchanger module and the second heat exchanger module includes a section of copper tubing connected to the aluminum, wherein the presence of the copper tubing facilitates field replacement of the first heat exchanger module without replacing the second heat exchanger module.

18. The first air conditioning unit of claim 13 further comprising a first attachment rail attached to a first end of the first and second heat exchanger modules, and a second attachment rail attached to a second end of the first and second heat exchanger modules, wherein each of the first and second attachment rails has a long dimension that is substantially parallel to the width of the first heat exchanger module and substantially parallel to the width of the second heat exchanger module.

19. The first air conditioning unit of claim 13 further comprising multiple attachment center clips attaching adjacent heat exchanger modules at an inside surface of the heat exchanger assembly.

20. The first air conditioning unit of claim 13 further comprising:
a top housing section, wherein the first motor is attached to the top housing section, the first air conditioning unit further comprising multiple attachment top clips attaching the heat exchanger assembly to the top housing section; and
a base section, wherein the first compressor is attached to the base section, the first air conditioning unit further comprising multiple attachment bottom clips attaching the heat exchanger assembly to the base section.

21. An inventory of air conditioning units, including multiple first air conditioning units of claim 13, wherein the inventory further includes multiple second air conditioning units, wherein each second air conditioning unit includes:
a second heat exchanger assembly comprising at least a second heat exchanger module and a third heat exchanger module, and no first heat exchanger module, wherein the second heat exchanger module and the third heat exchanger module are arranged in parallel with respect to air that passes through the second heat exchanger assembly, and wherein the second heat exchanger assembly includes connecting refrigerant conduit between the second heat exchanger module and the third heat exchanger module, and wherein each of the second and third heat exchanger modules include multiple parallel multi-tubes, the multi-tubes in each heat exchanger module being parallel to each other geometrically and arranged in parallel with respect to the flow of the refrigerant, each multi-tube having multiple contiguous parallel refrigerant passageways arranged in at least one row, and wherein each heat exchanger module includes multiple fins between the multi-tubes, wherein the fins are bonded to the multi-tubes;
a second fan positioned and configured to move air through the second heat exchanger assembly;
a third electric motor for driving the second fan; and
a second compressor configured to compress refrigerant;
wherein, at least before the first heat exchanger assemblies and the second heat exchanger assemblies are assembled, the second heat exchanger modules of the first heat exchanger assemblies and the second heat exchanger modules of the second heat exchanger assemblies are interchangeable; and
wherein the second air conditioning units have a capacity that is significantly different than a capacity of the first air conditioning units, and the third heat exchanger modules have at least one dimension that is significantly different than a corresponding dimension on the first heat exchanger modules.

22. A building including the first air conditioning unit of claim 13, wherein the building forms an enclosure containing a space having a temperature that is conditioned by the first air conditioning unit.

23. A first air conditioning unit comprising:
a first heat exchanger assembly comprising at least a first heat exchanger module and a second heat exchanger module, wherein the first heat exchanger module and the second heat exchanger module are arranged in parallel with respect to air that passes through the first heat exchanger assembly, and the first heat exchanger module;
a first fan positioned and configured to move air through the first heat exchanger assembly;
a first electric motor for driving the first fan; and
a first compressor configured to compress refrigerant;
the first air conditioning unit further comprising at least one of:
a spacer between the first heat exchanger module and the second heat exchanger module, wherein the spacer is configured to significantly reduce the amount of air that passes between the first heat exchanger module and the second heat exchanger module, and multiple substantially right-angle bends at corresponding locations in the first heat exchanger module, the spacer, and the second heat exchanger module,
multiple parallel multi-tubes in each heat exchanger module, the multi-tubes being parallel to each other geometrically and arranged in parallel with respect to the flow of the refrigerant, each multi-tube having multiple contiguous parallel refrigerant passageways arranged in at least one row, and multiple fins between the multi-tubes, wherein the fins are bonded to the multi-tubes, and a refrigerant header at each end of each heat exchanger module, wherein each header is connected to each multi-tube of the module for the passage of the refrigerant through the multi-tube, except for a top and a bottom multi-tube of each module, wherein the top and bottom multi-tubes of each module are not connected to the headers for passage of the refrigerant,
aluminum, wherein the first heat exchanger module and the second heat exchanger module each consist essentially of the aluminum, and a connecting refrigerant conduit between the first heat exchanger module and the second heat exchanger module includes a section of copper tubing connected at each end to the aluminum, wherein the presence of the copper tubing facilitates field replacement of the first heat exchanger module without replacing the second heat exchanger module,
a first attachment rail attached to a first end of the first and second heat exchanger modules, and a second attachment rail attached to a second end of the first and second heat exchanger modules, wherein each of the first and second attachment rails has a long dimension that is substantially parallel to the width of the first heat exchanger module and substantially parallel to the width of the second heat exchanger module, or
multiple attachment center clips attaching adjacent heat exchanger modules at an inside surface of the heat exchanger assembly, a top housing section, wherein the first motor is attached to the top housing section, the first air conditioning unit further comprising multiple attachment top clips attaching the heat exchanger assembly to the top housing section, and a base section, wherein the first compressor is attached to the base section, the first air conditioning unit further comprising multiple attachment bottom clips attaching the heat exchanger assembly to the base section.

24. An inventory of air conditioning units, including multiple first air conditioning units of claim 23, wherein the inventory further includes multiple second air conditioning units, wherein each second air conditioning unit includes:
a second heat exchanger assembly comprising at least a second heat exchanger module and a third heat exchanger module, and no first heat exchanger module, wherein the second heat exchanger module and the third heat exchanger module are arranged in parallel with respect to air that passes through the second heat exchanger assembly; p1 a second fan positioned and configured to move air through the second heat exchanger assembly;
a third electric motor for driving the second fan; and
a second compressor configured to compress refrigerant;
wherein, at least before the first heat exchanger assemblies and the second heat exchanger assemblies are assembled, the second heat exchanger modules of the first heat exchanger assemblies and the second heat exchanger modules of the second heat exchanger assemblies are interchangeable;
wherein the second air conditioning units have a capacity that is significantly different than a capacity of the first air conditioning units; and
wherein the third heat exchanger modules have at least one dimension that is significantly different than a corresponding dimension on the first heat exchanger modules.

25. The first air conditioning unit of claim 23 comprising the spacer, wherein the spacer consists essentially of an extruded piece of material containing cuts in particular locations to provide for bending of the spacer at corners of the first heat exchanger assembly; the first air conditioning unit further comprising the multiple parallel multi-tubes in each heat exchanger module, the multi-tubes being parallel to each other geometrically and arranged in parallel with respect to the flow of the refrigerant, each multi-tube having multiple contiguous parallel refrigerant passageways arranged in one row, and multiple fins between the multi-tubes, wherein the fins are bonded to the multi-tubes; the first air conditioning unit further comprising the first attachment rail attached to a first end of the first and second heat exchanger modules, and the second attachment rail attached to a second end of the first and second heat exchanger modules, wherein each of the first and second attachment rails has a long dimension that is substantially parallel to the width of the first heat exchanger module and substantially parallel to the width of the second heat exchanger module.
